(19) United States
(12) Patent Application Publication
(10) Pub. No.: US 2026/0289270 A1
(43) Pub. Date: Sep. 24, 2026

(54) SYSTEM

(71) Applicant: SoftBank Group Corp., Tokyo (JP)

(72) Inventor: Tomohiro YAMADA, Tokyo (JP)

(73) Assignee: SoftBank Group Corp., Tokyo (JP)

(21) Appl. No.: 19/566,995

(22) Filed: Mar. 14, 2026

(30) Foreign Application Priority Data
Mar. 19, 2025 (JP) 2025-044986

(51) Int. Cl. G06N 3/0475; G06V 40/16; G10L 25/63

(52) U.S. Cl. CPC G06N 3/0475; G06V 40/161; G06V 40/171; G06V 40/172; G06V 40/174; G10L 25/63

(57) ABSTRACT

A system includes a processor, wherein the processor is configured to acquire a face image by using an imaging device, perform face recognition based on the acquired face image and analyze a facial expression in the acquired face image, and generate a prompt sentence for instructing a generative AI model to generate a response, the prompt sentence being generated based on an analysis result of the facial expression and input information from a user.

### CROSS-REFERENCE TO RELATED APPLICATION

This application is based on and claims priority under 35 USC 119 from Japanese Patent Application No. 2025-044986 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In recent years, generative AI models have been widely used to provide interactive dialogue functions to users. However, conventional dialogue systems generally generate responses based only on textual input from the user, without adequately considering the user's emotional state. As a result, such systems may return responses that are inappropriate to the user's current feelings, for example, failing to calm an angry user or failing to empathize with a sad user. Furthermore, users often have dissatisfaction and anxiety related to daily activities and work, but they may hesitate to communicate such feelings to other people. Existing systems do not sufficiently provide a friendly and approachable “window character” that encourages users to casually talk about these concerns while dynamically adapting to the user's emotional expressions. Accordingly, there is a demand for a system that can recognize a user's facial expression, generate a prompt sentence for a generative AI model based on both the expression analysis result and the user's input information, and thereby enable the generative AI model to generate more emotionally appropriate responses through a character that users can easily confide in.

### SUMMARY

To solve the above-described problems, an aspect of the present invention provides a system comprising a processor, wherein the processor is configured to acquire a face image by using an imaging device, perform face recognition based on the acquired face image, and analyze a facial expression in the acquired face image. The processor is further configured to generate a prompt sentence for instructing a generative AI model to generate a response, the prompt sentence being generated based on an analysis result of the facial expression and input information from a user. In addition, the processor is configured to input the generated prompt sentence to the generative AI model and transmit a response generated by the generative AI model to a terminal of the user. Furthermore, the processor is configured to control the generative AI model to mimic an automation character that serves as a window character through which the user can casually talk about dissatisfaction and anxiety regarding daily activities and work. By generating the prompt sentence in consideration of both the user's facial expression and the user's input information, and by causing the generative AI model to respond as an approachable automation character, the system can provide responses that are better matched to the user's emotional state while encouraging the user to express personal concerns in a natural manner.

The term “system” refers to an apparatus or combination of apparatuses including at least one processor and associated components that are configured to execute the functions described in the present specification and claims.

The term “processor” refers to one or more hardware processing units, such as a central processing unit (CPU), graphics processing unit (GPU), digital signal processor (DSP), or dedicated integrated circuit, which execute instructions to perform the processing operations described in the present specification and claims.

The term “imaging device” refers to a hardware device, such as a camera or image sensor, that captures an image of at least a part of a scene, including a face image of a user.

The term “face image” refers to an image including at least a region in which a face of a user appears, the image being captured by the imaging device and used for face recognition and facial expression analysis.

The term “face recognition” refers to processing that detects and identifies a face region in a face image, and optionally recognizes one or more attributes of the face, such as identity, orientation, or position, for use in subsequent analysis and response generation.

The term “facial expression” refers to a visual state of a user's face, as represented in the face image, that reflects or suggests an emotional condition of the user, such as joy, anger, sadness, or surprise.

The term “analyze a facial expression” refers to processing that extracts features from the face image and determines an analysis result indicating one or more emotional states or expression categories associated with the user.

The term “analysis result” refers to data derived from the analysis of the facial expression, including, for example, a label, score, or probability indicating a detected emotional state of the user.

The term “input information from a user” refers to information provided by the user to the system, including but not limited to text input, speech input converted to text, or other user-generated content that expresses the user's thoughts, feelings, dissatisfaction, or anxiety.

The term “prompt sentence” refers to a text string or set of text strings generated by the processor, the text string including instructions, context information, or both, for controlling the operation and output of the generative AI model.

The term “generative AI model” refers to a machine learning model, such as a large language model, that is capable of generating text or other content in response to input, including the prompt sentence, and that is configured to produce responses in accordance with the instructions contained in the prompt sentence.

The term “response” refers to output content generated by the generative AI model based on the prompt sentence, the output content including at least text intended to be presented to the user by the system.

The term “terminal of the user” refers to an electronic device operated by the user, such as a smartphone, tablet, personal computer, or other communication device, that is capable of transmitting user input information to the system and receiving responses from the system.

The term “automation character” refers to a virtual character or persona that is implemented by the system through the generative AI model, the virtual character being controlled so as to behave in a predetermined manner, including mimicking a robot-like or automated entity.

The term “window character” refers to an interface character, including the automation character, that serves as a point of contact through which the user can casually talk or communicate dissatisfaction and anxiety regarding daily activities and work, while receiving emotionally appropriate responses from the system.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

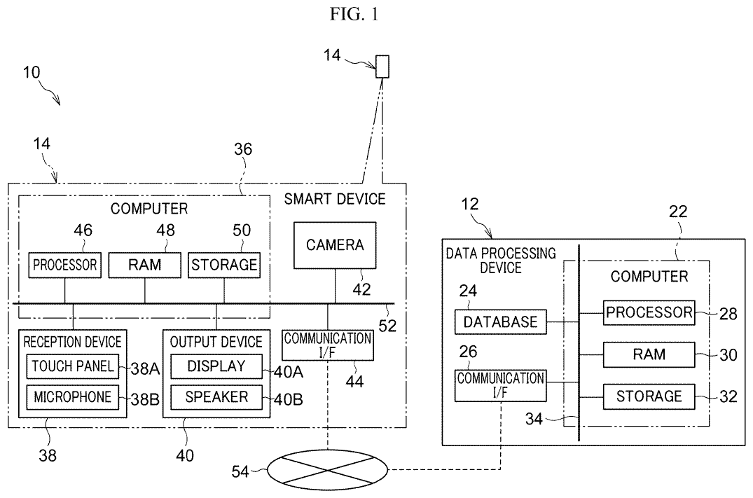

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

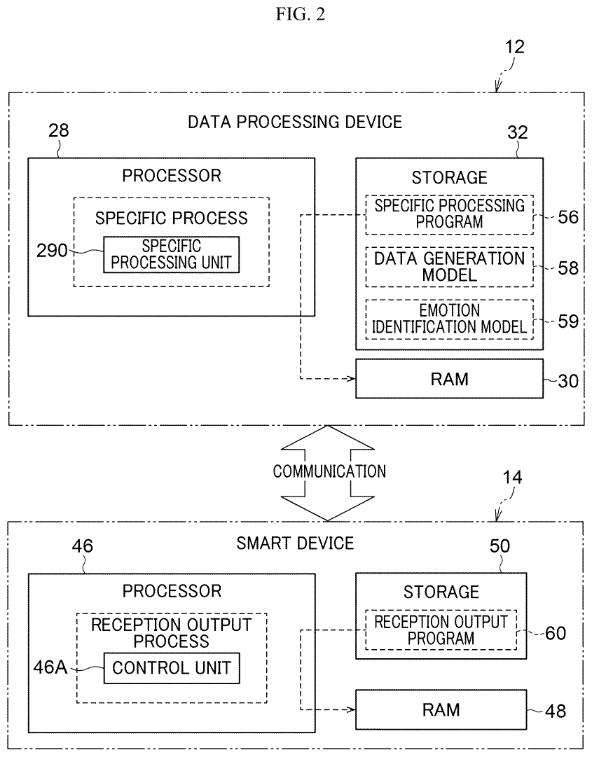

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional dialogue systems that utilize machine learning or generative AI models typically treat user input as text only and do not robustly incorporate real-time emotional states derived from visual signals such as facial expressions. As a result, these systems often generate responses that are technically accurate but contextually inappropriate, lacking empathy or alignment with the user's current emotional condition. From a computer-technology standpoint, existing architectures generally separate emotion recognition modules from dialogue-generation modules, with ad hoc or static interfaces between them. This separation leads to several technical problems.

First, there is no standardized data processing pipeline that converts low-level image data of a user's face into structured emotion data and then into a machine-understandable prompt sentence suitable for a generative AI model. The absence of such a pipeline causes inefficiencies in data flow, increased latency due to redundant processing, and difficulty in maintaining consistent state between client devices and server-side AI services.

Second, prior systems do not clearly partition computation between terminal-side resources (such as mobile devices performing image capture and lightweight processing) and server-side resources (such as cloud-based emotion analysis services and generative language models). This often results in either excessive load on the terminal, which has limited computational and power resources, or excessive network overhead by transmitting raw image data and unstructured context to server-side components. Such imbalanced distribution of processing degrades responsiveness, scalability, and reliability of the overall computer system.

Third, known systems lack a structured mechanism to encode both the user's emotional state and a virtual dialogue agent's persona (for example, personality traits, speech style, and response policy) into a single, machine-readable prompt sentence. Without this mechanism, the generative AI model cannot consistently produce dialogue-type responses that are both emotion-aware and persona-consistent. This yields unpredictable outputs and complicates integration testing, logging, and optimization in software deployment.

Accordingly, there is a need for an improved computer-implemented system and processing method that: (i) efficiently acquires facial image data on a terminal device and converts it into compact facial feature data; (ii) utilizes a server or external information processing service to derive structured emotion data; (iii) programmatically constructs a prompt sentence that integrates the emotion data, user input, and virtual agent profile; and (iv) supplies this prompt sentence to a generative AI model to generate a dialogue-type response that is technically consistent, latency-optimized, and better aligned with the user's emotional state. The technical problem to be solved is to improve the architecture, data flow, and processing pipeline of computer systems that perform emotion-aware, generative dialogue, thereby enhancing computational efficiency, modularity, and the quality of machine-generated responses.

The specific processing by the specific processing unit 290 of the data processing device 12 in Example 1 is realized by the following means.

The present invention provides a server comprising a processor configured to receive facial feature data extracted on a terminal device from facial image data of a user, execute emotion classification processing on the facial feature data to generate structured emotion data indicating an emotional state of the user, receive input information supplied from the terminal device as text data or voice-recognition data, generate a prompt sentence as a generation input sentence by programmatically combining at least the emotion data, the input information, and profile information of a virtual dialogue agent including personality information, speech style information, and response policy information, transmit the prompt sentence to a generative AI model included in a generative information processing apparatus that performs natural language processing, and acquire, from the generative AI model, a dialogue-type response sentence corresponding to the prompt sentence for delivery to the terminal device. This enables an integrated, computer-implemented processing pipeline in which terminal-side devices perform lightweight image capture and facial feature extraction, server-side components perform emotion classification and prompt construction, and a generative AI model produces emotion-aware, persona-consistent dialogue responses with reduced latency, improved resource allocation, and enhanced reliability of the overall emotion-aware conversational system.

The term “system” refers to an arrangement of one or more hardware devices and software components that cooperate to execute the processing described in the claims, including at least a processor, a terminal device, and a communication network.

The term “processor” refers to a hardware computation unit, such as a central processing unit, microprocessor, or processing circuitry, that executes instructions stored in a memory to perform the functions described in the claims.

The term “imaging device” refers to an image acquisition component, such as a digital camera or image sensor, that captures facial image data of a user.

The term “facial image data” refers to digital image data representing at least a part of a user's face, including still images or frames extracted from a video stream.

The term “user” refers to a human operator who interacts with the system by providing facial image data and input information and receiving response sentences.

The term “image processing” refers to computational operations applied to facial image data, including at least detection of a facial region and extraction of facial feature points.

The term “facial region” refers to a portion of facial image data that contains the user's face, specified, for example, by a bounding box or pixel coordinates.

The term “facial feature points” refers to a plurality of characteristic locations on the user's face, such as eyes, eyebrows, nose, and mouth corners, used to represent facial structure and expression.

The term “facial feature data” refers to structured data representing the facial feature points and optionally associated attributes, including coordinates, shapes, or other numerical descriptors.

The term “emotion classification processing” refers to a computational procedure that maps facial feature data to one or more emotion categories, such as happiness, anger, sadness, surprise, or neutral.

The term “external information processing service” refers to a remotely provided computational service, accessible via a communication network, that performs at least part of the emotion classification processing.

The term “internal computation” refers to processing executed by the processor or by a local computing resource of the system, without using a separate external information processing service.

The term “emotion data” refers to structured information indicating an estimated emotional state of the user, including at least one emotion category and optionally an associated confidence value or timestamp.

The term “input information” refers to user-provided content in textual or spoken form, including at least character string data entered via a user interface or text obtained by voice recognition.

The term “character string data” refers to data expressed as a sequence of characters, such as letters, numbers, and symbols, representing user input or internally generated text.

The term “voice recognition data” refers to textual data produced by applying a speech recognition process to audio signals of the user's voice.

The term “character string generation processing” refers to a procedure in which the processor constructs or modifies text by concatenating, formatting, or otherwise programmatically generating character strings.

The term “prompt sentence” refers to a text string prepared as an input for a generative AI model, the text string including at least the user's emotional state and the user's input information.

The term “generation input sentence” refers to a prompt sentence used as input to a generative AI model for generating a response sentence.

The term “generative AI model” refers to a machine-learned model that performs natural language processing to generate text, including at least a generative language model trained on large amounts of textual data.

The term “generative information processing apparatus” refers to a computing system or service that hosts and executes the generative AI model to process input text and generate output text.

The term “natural language processing” refers to computational techniques for analyzing, understanding, and generating human language in textual form.

The term “dialogue-type response sentence” refers to a generated text string that is formatted and phrased as part of a conversational exchange with the user.

The term “response sentence” refers to a dialogue-type response sentence generated by the generative AI model based on the prompt sentence.

The term “response data” refers to structured information that includes at least the response sentence and is suitable for transmission to and display on a terminal device.

The term “terminal device” refers to an end-user computing device, such as a smartphone, tablet, or personal computer, that captures facial image data, provides a user interface for input information, and displays response sentences.

The term “display unit” refers to a visual output component of the terminal device, such as a liquid crystal display, organic light-emitting diode display, or other screen, that presents information to the user.

The term “server device” refers to a computing apparatus, typically located remotely from the terminal device, that executes at least the emotion classification processing and the generative AI model processing.

The term “communication network” refers to a wired or wireless network, such as the Internet, a mobile communication network, or a local area network, that enables data transfer between the terminal device, the server device, and external services.

The term “virtual dialogue agent” refers to a software-defined conversational entity whose behavior and responses are generated by the generative AI model based on specified profile information.

The term “personality information” refers to data specifying behavioral traits of the virtual dialogue agent, such as friendliness, formality, or degree of assertiveness.

The term “speech style information” refers to data specifying stylistic attributes of utterances of the virtual dialogue agent, such as tone, level of politeness, vocabulary choice, and sentence structure.

The term “response policy information” refers to data specifying rules or guidelines that govern how the virtual dialogue agent should respond, including constraints on content, level of detail, and emotional stance.

The term “profile information of a virtual dialogue agent” refers to a set of attributes including at least personality information, speech style information, and response policy information, used to control the behavior of the generative AI model.

The term “virtual dialogue agent in accordance with the emotional state of the user” refers to a configuration in which the virtual dialogue agent's responses are adapted or selected based on the emotion data representing the user's current emotional state.

In one embodiment, the system includes a server, a terminal, and a communication network. The server includes at least one processor and a memory storing control programs and parameter data. The terminal includes at least one processor, a memory, an imaging device, and a display unit. The imaging device is implemented, for example, by a front-facing or rear-facing digital camera integrated into a smartphone, tablet, or personal computer. The server and the terminal communicate via a wired or wireless communication network such as a cellular data network or a wireless local area network.

The terminal executes an application program that controls the imaging device and performs local image processing. The terminal uses an image processing library, such as an implementation compatible with an open-source computer vision library, to perform face detection and facial landmark extraction. The server executes a backend application implemented in a server-side framework and uses an external emotion analysis service and a generative AI model for natural language processing.

The terminal acquires raw facial image data by controlling the imaging device. The terminal configures the imaging device to capture images at a predetermined resolution, for example, 1280×720 pixels in RGB format. The terminal stores each captured frame in a frame buffer in memory. The terminal uses the image processing library to perform face detection on the frame. In one example, the terminal applies a cascade classifier based on Haar-like features or a deep neural network-based detector to locate a facial region. The terminal represents the facial region as a rectangular bounding box with integer coordinates (x, y, width, height) in the image coordinate system.

The terminal applies a facial landmark extraction algorithm to the detected facial region. The terminal uses a facial landmark model that has been previously trained, for example a regression-based model or a shallow neural network model that outputs a fixed number of two-dimensional points. The terminal computes an array of facial feature points, each feature point including at least an (x, y) coordinate and an index indicating the type of point (eye corner, eyebrow point, nose tip, mouth corner, and so on). The terminal aggregates these feature points into facial feature data, for example as a fixed-length vector of normalized coordinates relative to the bounding box, or as a structured array in memory.

The terminal may further preprocess the facial data to reduce network load. The terminal normalizes the coordinates by dividing by the width and height of the bounding box so that all coordinates lie in a predetermined numeric range. The terminal may optionally crop the facial region and compress the cropped image as a JPEG or PNG file, but in one preferred embodiment the terminal transmits only the compact facial feature data to the server. This reduction of data size decreases bandwidth usage and CPU load on the server, thereby improving the overall data management and communication efficiency of the system.

The server receives the facial feature data from the terminal and stores it temporarily in a request buffer. The server performs emotion classification processing based on the facial feature data. In one embodiment, the server forwards a representation of the facial feature data to an external emotion analysis service that provides an application programming interface for emotion estimation. In another embodiment, the server performs emotion classification by executing an internal neural network model trained on facial landmark sequences.

When the server uses an internal model, the server applies a feed-forward neural network or a convolutional neural network that takes the facial feature data vector as input. The server normalizes the input vector, applies one or more hidden layers with non-linear activation functions, and calculates an output vector of scores corresponding to predefined emotion categories such as happiness, anger, sadness, surprise, fear, and neutral. The server applies a softmax function to convert the scores into probabilities and selects the emotion category with the highest probability as the dominant emotion. The server defines an emotion data structure that contains at least the dominant emotion label and the associated probability value. The server may store the emotion data together with a timestamp and a session identifier in a structured log for later analysis.

The server transmits the emotion data to the terminal. The terminal parses the emotion data and updates an internal state object that represents the current emotional state of the user, for example by storing a string such as “happiness” and a numerical confidence value. The terminal uses this state in subsequent processing to construct a prompt sentence.

The user provides input information to the terminal. The user enters text via an input field displayed on the display unit, or the user speaks into a microphone and the terminal converts speech into text using a speech recognition engine. The terminal obtains the input information as character string data, for example: “What's the weather today?”. The terminal may apply basic normalization to the input information, such as trimming leading and trailing spaces, converting certain punctuation to a standard form, or limiting the maximum length of the input.

The terminal constructs a prompt sentence for a generative AI model. The terminal executes a character string generation process in which the terminal programmatically combines the emotion data, the user's input information, and profile information of a virtual dialogue agent. The profile information includes at least personality information, speech style information, and response policy information. The personality information may specify traits such as “cheerful and supportive”; the speech style information may specify instructions such as “respond in a friendly and conversational tone”; the response policy information may define constraints such as “provide concise, practical advice”.

The terminal uses a predetermined template to embed these elements into a single, structured prompt sentence. The prompt sentence may take the following form:
“User emotion: happiness. User question: What's the weather today? You are an automated character. Answer in a cheerful and friendly tone in a conversational style.”

In another example, when the emotion data indicates sadness and the user asks for advice, the prompt sentence may be:
“User emotion: sadness. User question: How should I handle a mistake I made at work? You are an automated character that supports the user emotionally. Respond gently and supportively with practical advice.”

In still another example, when the emotion data indicates anger, the prompt sentence may be:
“User emotion: anger. User question: My train was delayed again and I'm really angry. What can I do to calm down? You are an automated character that helps users manage anger. Respond with empathy and practical tips in natural dialogue form.”

The terminal transmits this prompt sentence to the server as text data. The server receives the prompt sentence and prepares a request to the generative AI model. In one embodiment, the generative AI model is a transformer-based generative language model hosted on a remote computing infrastructure. The model comprises multiple layers of self-attention and feed-forward neural networks, and is trained on a large corpus of natural language text using unsupervised learning. During training, the server (or a training system) optimizes model parameters by minimizing a loss function such as cross-entropy loss between predicted tokens and ground-truth tokens, and updates weights by a gradient-based optimization method such as stochastic gradient descent or an adaptive optimizer. Data augmentation may be used in training, such as random masking or shuffling of input tokens, to improve robustness.

At inference time, the server tokenizes the prompt sentence into tokens using a predefined tokenizer associated with the generative AI model. The server feeds the tokens into the model, layer by layer. Each layer applies multi-head self-attention, where the model calculates attention weights between tokens based on learned query, key, and value vectors, and then applies position-wise feed-forward networks. The model produces a probability distribution over the next token at each generation step. The server uses generation parameters such as temperature, top-k sampling, or nucleus sampling to select output tokens and constructs the response sentence as a sequence of tokens. The server decodes the tokens back into text.

The server thus generates a dialogue-type response sentence that reflects both the user's input and the emotion data encoded in the prompt sentence. Because the prompt sentence explicitly encodes the emotional state, personality profile, speech style, and response policy of the virtual dialogue agent, the generative AI model applies a non-conventional, rule-like conditioning mechanism arising from the specific prompt structure. This differs from human operators manually choosing tone and style; the generative AI model automatically adjusts lexical choice, sentence structure, and level of empathy based on the explicit information encoded in the prompt sentence.

The server transmits the response sentence back to the terminal as response data. The terminal receives the response data, parses the response sentence, and displays it on the display unit in a dialogue format. The terminal may show the user's original question and the system's response in a chat-like interface. The user can read the response and, if desired, provide further input, which the terminal and server process in the same manner as described above.

This architecture provides several technical effects. The division of processing between the terminal and the server improves computational efficiency. The terminal performs only lightweight operations such as image acquisition, face detection, landmark extraction, and prompt sentence construction, which are suitable for a mobile device with limited resources. The server performs computationally demanding tasks such as emotion classification by a neural network and natural language generation by a large generative AI model, which are better suited for high-performance hardware. By transmitting compact facial feature data rather than full images, the system reduces network bandwidth and latency, thereby improving response time and scalability.

The use of structured facial feature data and emotion data in the prompt sentence also improves the quality and consistency of the response sentence. Because the prompt sentence encodes emotion categories and confidence values in a machine-readable manner, the generative AI model receives a more precise conditioning signal than in systems that attempt to infer emotion solely from free-form text. This leads to lower error rates in emotional alignment and more stable response patterns across sessions, which can be measured by comparing automatic sentiment analysis over generated responses.

The server uses a well-defined data flow and modular architecture. The server can include distinct modules for: (i) receiving and validating facial feature data; (ii) performing emotion classification via an internal emotion network or external service; (iii) logging emotion and session metadata; (iv) constructing or verifying prompt sentences; (v) performing tokenization and detokenization; (vi) interfacing with the generative AI model; and (vii) returning response data to the terminal. Because each module handles a specific data structure and transformation, the system achieves reproducible behavior and facilitates optimization such as caching emotion results or reusing prompt fragments.

The system also improves the underlying computer technology by optimizing how multiple AI components are orchestrated. The server does not merely automate a human conversation; instead, the server enforces a non-conventional procedural sequence: image-based emotion estimation is computed from structured facial features, then encoded into a prompt sentence that also includes a machine-readable persona description, and then applied as a control signal for a high-dimensional generative language model. This composition of components uses specific data structures and algorithmic steps that are not present in traditional text-only chat systems or static rule-based chatbots.

In another embodiment, the terminal may perform additional local preprocessing, such as temporal smoothing of emotion estimates. The terminal may maintain a sliding window of recent emotion data and apply a digital filter or a recurrent neural network to derive a stabilized emotional state. The terminal may then include this stabilized state, rather than a single-frame estimate, in the prompt sentence. This reduces noise due to transient facial expressions and improves the reliability of emotion-aware dialogue.

In yet another embodiment, the server may adapt parameters of the generative AI model based on historical interaction data. The server may adjust temperature, maximum token length, or prompt structure depending on the distribution of emotion data over time, thereby optimizing computational cost and response appropriateness. For example, when the emotion data indicates high distress (e.g., repeated sadness), the server may select a longer maximum token length to allow more detailed, supportive responses.

The system can also be implemented using different types of emotion analysis modules. The server may use an external cloud-based face analysis service, or the server may use a locally hosted convolutional network that processes cropped images instead of facial landmarks. In the latter case, the server receives a compressed cropped image from the terminal, decompresses it, performs normalization (e.g., resizing and mean-variance normalization), and feeds the image into a convolutional neural network followed by fully connected layers. The network outputs emotion scores that are processed in the same manner as emotion scores derived from facial feature data.

The generative AI model itself may take various forms. In some embodiments, the model is a decoder-only transformer with a fixed number of layers and parameters; in other embodiments, the model is a sequence-to-sequence transformer with an encoder and a decoder, where the encoder processes the prompt sentence and the decoder generates the response sentence. The training data may include pairs of prompts and responses labeled with emotion or style metadata to improve alignment between prompt instructions and generated text. The model can be further fine-tuned using reinforcement learning from human feedback, in which the server collects human ratings of response quality and uses these ratings to update the model parameters in a feedback loop.

The described system thus provides a concrete, technical implementation that goes beyond generic data acquisition and display. The terminal and the server cooperate to perform specific data transformations—image to facial features, facial features to emotion data, emotion data and user input to prompt sentence, prompt sentence to token sequence, token sequence to generated text—using specified algorithms and neural network architectures. This cooperation leads to improved response latency, reduced network load, more accurate emotional alignment, and more stable persona-consistent dialogue, thereby improving the functioning of the computer system itself.

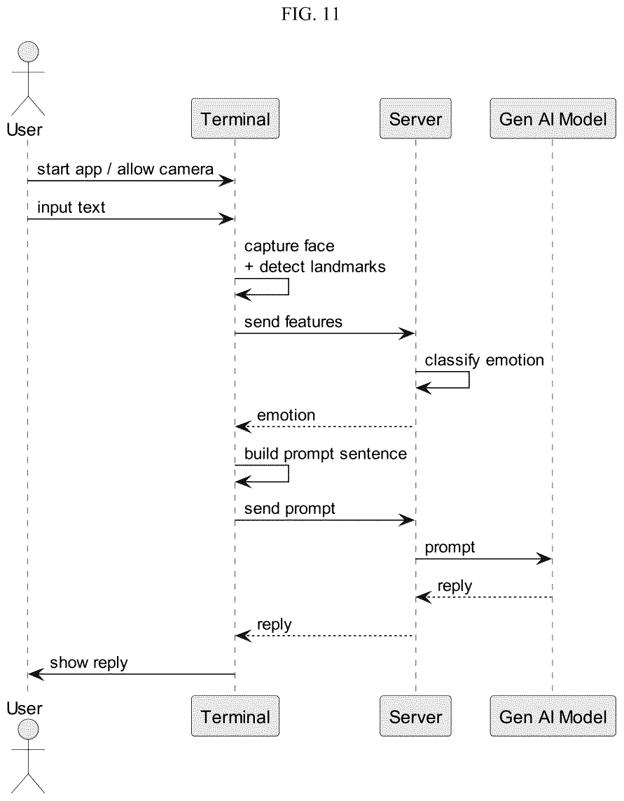

The following describes the processing flow using FIG. 11.

### Step 1:

The user starts an application on the terminal and grants permission to use the camera, microphone (optionally), and network.
Input: User operation (app launch, permission settings).
The terminal loads UI components, allocates memory buffers for image frames and temporary data, and initializes libraries for image processing and network communication.
Output: An active application state in which the terminal is ready to capture facial image data and user input.

### Step 2:

The terminal activates an imaging device and captures facial image data of the user.
Input: Control commands from the terminal to the imaging device driver and the current scene in front of the camera.
The terminal configures the camera resolution (for example, 1280×720 pixels, RGB) and frame rate, then reads raw frame data from the camera driver into a frame buffer in memory.
Output: Raw facial image data (a 2D array of pixel values) stored in the terminal's memory.

### Step 3:

The terminal performs face detection on the captured facial image data.
Input: Raw facial image data.
The terminal uses an image processing library to run a face detector (for example, a cascade classifier or a DNN-based detector). The terminal scans the image, computes features (such as Haar-like features or convolution outputs), and compares them against trained classifier parameters to locate one or more facial regions.
Output: One or more facial bounding boxes represented by coordinates (x, y, width, height).

### Step 4:

The terminal performs facial landmark extraction within the detected facial region.
Input: Facial image data and facial bounding box coordinates.
The terminal crops the facial region or maps normalized coordinates within the bounding box and applies a pre-trained facial landmark model. The terminal computes a fixed set of keypoint coordinates (for example, 68 or 81 points) by applying regression or neural network inference, resulting in (x, y) pairs for eyes, eyebrows, nose, mouth, and jawline.
Output: Facial feature data including a structured list or vector of landmark coordinates associated with the facial bounding box.

### Step 5:

The terminal preprocesses the facial feature data for transmission to the server.
Input: Facial feature data and facial bounding box information.
The terminal normalizes landmark coordinates (for example, dividing x and y by the width and height of the bounding box), converts floating-point values into a compact numeric representation, and packages them into a structured data format in memory. If configured, the terminal may additionally crop the face image and compress it, but the primary data is the normalized landmark vector.
Output: Compact facial feature payload suitable for network transmission.

### Step 6:

The terminal transmits the facial feature payload to the server over a communication network.
Input: Facial feature payload, session identifier, and timestamp.
The terminal opens a secure network connection (for example, HTTPS), constructs a request body containing the facial feature payload, and sends the request to a predefined server endpoint. The terminal stores a reference to this pending request for later correlation with the response.
Output: A network request sent to the server containing facial feature data associated with the user session.

### Step 7:

The server receives and validates the facial feature payload.
Input: Network request containing facial feature payload, session identifier, and timestamp.
The server parses the request, checks that the payload format is correct, verifies that the number of landmarks and numeric ranges are within expected bounds, and discards or flags invalid data. The server stores valid facial feature data in a temporary processing buffer.
Output: Validated facial feature data ready for emotion classification processing.

### Step 8:

The server executes emotion classification processing based on the facial feature data.
Input: Validated facial feature data.
The server normalizes the input vector if required by the model and feeds it into an emotion classification algorithm, such as a neural network that outputs scores for multiple emotion categories. The server computes a probability for each category (for example, via a softmax layer) and identifies the category with the highest probability as the dominant emotion.
Output: Emotion data including at least a dominant emotion label (for example, “happiness”, “anger”, “sadness”, “surprise”) and an associated confidence value.

### Step 9:

The server transmits the emotion data back to the terminal.
Input: Emotion data and session identifier.
The server constructs a response message containing the emotion label and confidence value, associates it with the appropriate session identifier, and sends it over the communication network using a response to the terminal's prior request.
Output: Network response containing emotion data for the corresponding terminal session.

### Step 10:

The terminal receives the emotion data and updates the internal emotion state.
Input: Network response with emotion label and confidence value.
The terminal parses the response, extracts the emotion label and confidence, and stores them in an internal state object or memory structure associated with the currently active user session. The terminal may display a subtle indicator or may silently maintain this state for later use in prompt construction.
Output: Updated internal emotion state representing the user's current emotional condition.

### Step 11:

The user provides input information to the terminal as text or speech.
Input: User operation on the terminal UI (keyboard input or spoken utterance).
The terminal displays an input field or listens for audio; the user types a question (for example, “What's the weather today?”) or speaks, and the terminal converts speech to text using a speech recognition engine.
Output: User input information represented as character string data stored in the terminal's memory.

### Step 12:

The terminal normalizes and validates the user input information.
Input: Raw character string data.
The terminal trims whitespace, removes unsupported control characters, checks that the length does not exceed a predefined maximum, and optionally converts the text to a canonical representation (for example, normalizing punctuation).
Output: Cleaned user input text suitable for use in a prompt sentence.

### Step 13:

The terminal constructs a prompt sentence by combining the emotion data, the user input text, and virtual agent profile information.
Input: Emotion label and confidence, cleaned user input text, and stored virtual dialogue agent profile (personality, speech style, response policy).
The terminal selects an appropriate template and fills in the placeholders with the current emotion and user question. The terminal then appends or embeds persona-related instructions describing how the generative AI model should respond. The terminal performs string concatenation and formatting operations to create a single continuous prompt sentence.
Output: A prompt sentence for the generative AI model, for example:
“User emotion: happiness. User question: What's the weather today? You are an automated character. Answer in a cheerful and friendly tone in a conversational style.”

### Step 14:

The terminal transmits the prompt sentence to the server for generative processing.
Input: Prompt sentence and session identifier.
The terminal opens or reuses a secure network connection, places the prompt sentence into the body of an HTTP request to a generative-processing endpoint, and sends the request to the server. The terminal tags the request with the session identifier so that the server can correlate the prompt with prior emotion data.
Output: Network request containing the prompt sentence to be processed by the server.

### Step 15:

The server receives and verifies the prompt sentence.
Input: Network request carrying the prompt sentence and session identifier.
The server parses the request, checks that the prompt is non-empty and within length limits, and inspects it for required structural components (for example, presence of “User emotion:” and “User question:” segments). The server stores the valid prompt in a buffer for generative processing.
Output: Validated prompt text and associated metadata ready for input to the generative AI model.

### Step 16:

The server prepares input tokens for the generative AI model.
Input: Validated prompt sentence.
The server uses a tokenizer associated with the generative AI model to convert the prompt sentence into a sequence of token identifiers. The server may truncate or pad the sequence according to model limits and set inference parameters such as maximum output length, temperature, and sampling strategy.
Output: Tokenized prompt sequence and generation parameters.

### Step 17:

The server executes inference on the generative AI model to generate a dialogue-type response sentence.
Input: Tokenized prompt sequence and generation parameters.
The server feeds the token sequence into the generative AI model, which performs layer-by-layer computations (self-attention and feed-forward operations) to compute probability distributions over candidate next tokens. The server repeatedly applies these computations, sampling or selecting output tokens based on the probability distributions and generation parameters until an end-of-sequence condition is met.
Output: Generated token sequence representing the response sentence.

### Step 18:

The server decodes the generated token sequence and formats the response sentence.
Input: Generated token sequence.
The server converts tokens back into text using the same tokenizer, removes leading or trailing control characters and extraneous whitespace, and ensures the output conforms to a natural, dialogue-type form. The server may add minimal metadata, such as an identifier or timestamp, to the response payload.
Output: Response sentence as text data, for example:
“It looks like a great day ahead! The forecast shows clear skies and mild temperatures. It's perfect for a walk outside.”

### Step 19:

The server sends the response sentence to the terminal as response data.
Input: Response sentence text and session identifier.
The server constructs a response message containing the response sentence, associates it with the relevant session, and transmits it to the terminal over the communication network using a standard response mechanism (for example, HTTP response with status code 200).
Output: Network response containing the dialogue-type response sentence.

### Step 20:

The terminal receives the response data and displays the response sentence to the user.
Input: Network response including the response sentence text.
The terminal parses the response, extracts the response sentence, and inserts it into a conversation view alongside the user's original input. The terminal updates UI components (for example, chat bubbles or text labels) and scrolls the display unit as necessary so that the new response is visible.
Output: Updated display showing a dialogue between the user and a virtual dialogue agent, where the response is aligned with the emotion state encoded in the prompt sentence.

### Step 21:

The user reviews the displayed response and optionally continues the interaction.
Input: Displayed conversation and the user's current emotional and informational needs.
The user reads the system's response, reacts (for example, smiling, frowning, or thinking), and may choose to provide further input via text or speech. The presence of the camera and ongoing processing allows the system to repeat Steps 2 onward, capturing updated facial image data and emotion states and generating new prompt sentences and responses.
Output: A continuous, emotion-aware conversational session in which subsequent cycles reuse and update the processing pipeline to adapt to the user's evolving emotional state and queries.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional information provision and advertising systems mainly rely on static user profiles, coarse-grained behavioral logs, or manually defined segments to select content for presentation. Such systems typically treat users as belonging to relatively fixed categories and do not incorporate a fine-grained, real-time assessment of a user's emotional state at the moment of interaction. As a result, the systems often present content that feels irrelevant, intrusive, or even inappropriate to the user's current situation.

Furthermore, even when face recognition or sentiment analysis is used, existing systems generally treat the analysis result as an auxiliary signal and do not integrate it in a structured and repeatable way into downstream content generation logic. In particular, there is insufficient linkage between: (i) the low-level visual signal (face image), (ii) the derived emotional state, (iii) the user's explicit input (text or speech) in a given context, and (iv) the instructions provided to a generative AI model that actually produces the content. This weak coupling leads to under-utilization of available multimodal data and reduces the effectiveness, controllability, and predictability of generative AI outputs.

Additionally, many generative AI based interfaces are designed as generic chatbots and do not maintain a consistent “character” or “role” that can serve as a stable, emotionally adaptive interaction window for users. Users who wish to casually express dissatisfaction or anxiety in daily activities or tasks often encounter generic, context-insensitive responses. These responses do not adequately exploit the power of generative models to provide nuanced, emotionally aligned communication, and can negatively impact user trust and engagement.

From the perspective of computer technology, there is a need for an improved architecture and processing flow that: (i) systematically converts raw sensor data into structured emotional context, (ii) rigorously couples that context with user input to form machine-usable prompt sentences, (iii) controls a generative AI model in a way that produces predictable, role-constrained outputs, and (iv) uses interaction logs to refine future prompt generation and model behavior. Without such an architecture, the computer system cannot efficiently leverage multimodal signals to improve the technical quality of content selection and generation, such as latency, relevance, adaptability, and controllability of the generative AI model.

Accordingly, an object of the present invention is to provide a system and a server-side processing mechanism that improve the functioning of computers by: transforming image data, emotion analysis results, and user input into structured prompt sentences; controlling a generative AI model with explicit emotional and contextual constraints; and using accumulated interaction data to optimize subsequent prompt generation and model operation, thereby enabling more precise, stable, and technically improved emotion-aware content delivery.

The specific processing by the specific processing unit 290 of the data processing device 12 in Application Example 1 is realized by the following means.

The present invention provides a server comprising at least one processor and at least one memory storing instructions that, when executed by the at least one processor, cause the server to perform operations including: receiving, from an information processing terminal carried or worn by a user, image data including a face of the user acquired by an imaging device; converting the image data into pixel data and applying a face region detection learning model to the pixel data to specify a face region of the user; applying an expression analysis learning model to the specified face region and estimating, based on pixel features of the face region, an emotional state of the user represented by an emotion label and an emotion score; receiving, from the information processing terminal, user input information based on text or speech; generating structured data by associating the user input information with the emotion label and the emotion score; generating, based on the structured data, a prompt sentence in a natural language that explicitly represents the emotional state and a context of the user and that is formed as instruction information to be input to a generative AI model of a generative information processing device; transmitting the prompt sentence to the generative AI model via a communication line and obtaining, from the generative AI model in response to the prompt sentence, information including advertisement information or content information; selecting, when the obtained information includes a plurality of candidate messages, at least one candidate message having a highest presentation priority based on at least the emotion score and an operation history of the user; transmitting the selected at least one candidate message to the information processing terminal together with control information for causing an information-providing character to present the selected at least one candidate message with an expression or a manner of speaking corresponding to the emotion label; and recording, in a storage device, the emotion label, the user input information, the prompt sentence, the obtained information including the advertisement information or the content information, and the operation history of the user together with identification information, and accumulating the recorded information for use in generation of a subsequent prompt sentence or adjustment of parameters used by at least one of the face region detection learning model, the expression analysis learning model, and the generative AI model. This enables a technical improvement in computer-based information provision by systematically transforming multimodal sensor and interaction data into structured prompt sentences that tightly control a generative AI model, thereby allowing stable, emotion-aware generation and selection of content, reducing mismatches between user state and presented information, and providing a consistent, role-constrained information-providing character that enhances the effectiveness, predictability, and adaptability of the underlying computing system.

The term “information processing terminal” refers to an electronic device including at least a processor, a memory, an input interface, a display unit, and a communication interface, which is carried or worn by a user and is capable of acquiring sensor data, presenting information, and communicating with a server over a communication network.

The term “imaging device” refers to a hardware component configured to capture image data, including at least an optical system and an image sensor, and is used as an image acquisition device to obtain images including a face of a user.

The term “image data” refers to digital data representing an image captured by an imaging device, the data including at least a plurality of pixels arranged in a two-dimensional array and encoded in a predetermined image format.

The term “pixel data” refers to numerical data obtained by decoding image data into a set of pixel values, each pixel value representing at least color or brightness information at a corresponding location in the image.

The term “face region” refers to a sub-region of pixel data corresponding to a portion of an image in which a face of a user is detected or specified, the sub-region being represented, for example, by coordinates of a bounding area or by a mask.

The term “face region detection learning model” refers to a machine-learned model that has been trained using sample images and associated annotations to detect or localize one or more face regions within pixel data and to output at least position information indicating such regions.

The term “expression analysis learning model” refers to a machine-learned model that has been trained using sample images of faces and associated expression or emotion labels to analyze pixel features of a face region and to estimate an emotional state of a user.

The term “emotional state” refers to an internal state of a user inferred from one or more signals, including at least facial expressions in a face region, and is represented by at least one emotion label and optionally an emotion score indicating a degree or intensity.

The term “emotion label” refers to symbolic data representing a category of an emotional state, such as joy, sadness, anger, surprise, fear, disgust, or neutrality, as inferred by an expression analysis learning model.

The term “emotion score” refers to numerical data representing a confidence level, probability, intensity, or strength associated with an estimated emotional state or emotion label.

The term “input interface” refers to a functional component of an information processing terminal that enables a user to provide input, the component including at least one of a touch panel, a keyboard, a pointing device, a microphone, or another sensor.

The term “user input information” refers to information provided by a user through an input interface, including at least text data, speech data converted into text, or selection information relating to items, categories, or commands.

The term “structured data” refers to data in which multiple pieces of information, such as a user's emotion label, emotion score, and user input information, are represented in a predefined format, such as a record, object, or tuple, with identifiable fields that can be processed by a program.

The term “prompt sentence” refers to a sequence of natural language text generated by a processor based on structured data, the sequence explicitly representing at least an emotional state and a context of a user, and being used as instruction information to control behavior of a generative AI model.

The term “generative AI model” refers to a machine-learned model configured to generate information, such as text or other media, in response to input instruction information including a prompt sentence, the model being implemented as part of a generative information processing device.

The term “generative information processing device” refers to an information processing apparatus, which may include one or more processors and memories, configured to execute a generative AI model to generate output information in response to input prompt sentences received from an external system.

The term “advertisement information” refers to generated information intended to promote a product, service, event, or brand, including at least one of descriptive text, call-to-action text, offers, or recommendations.

The term “content information” refers to generated information intended to be consumed by a user as informational or entertainment material, including at least articles, explanations, recommendations, or dialogue responses that are not limited to promotional content.

The term “information-providing character” refers to a virtual agent or avatar controlled by a program, the agent being represented visually and/or audibly on an information processing terminal and configured to present information to a user with a controllable expression or manner of speaking.

The term “expression of the information-providing character” refers to visual or behavioral attributes of an information-providing character, such as facial expression, posture, or animation patterns, that can be controlled to correspond to an emotion label.

The term “manner of speaking of the information-providing character” refers to characteristics of output speech or text presented by an information-providing character, including at least tone, politeness level, style, or wording, which can be controlled to correspond to an emotion label or a predefined role.

The term “communication line” refers to a logical or physical communication path, including at least one of a wired network, a wireless network, or a combination thereof, used to transmit data between a server, an information processing terminal, and a generative information processing device.

The term “operation history of the user” refers to data representing interactions performed by a user with respect to content presented by the system, including at least one of selection actions, click events, viewing durations, scrolling behavior, and dismissal operations.

The term “storage device” refers to a hardware component, such as a semiconductor memory or a magnetic or optical storage medium, configured to store data including emotion labels, user input information, prompt sentences, generated information, operation histories, and identification information.

The term “identification information” refers to information that enables association of multiple records or events with a same entity, such as a user, a session, or a device, while optionally being anonymized or pseudonymized, the information including at least an identifier value.

The term “presentation priority” refers to an order or ranking value assigned to a candidate message, the value being calculated based on at least one of an emotion score, an operation history, or other context, and used to select which candidate message to present to a user.

The term “candidate message” refers to one of a plurality of messages included in information generated by a generative AI model in response to a prompt sentence, each message representing a possible advertisement information item or content information item.

The term “role of the information-providing character” refers to a predefined functional or narrative identity assigned to an information-providing character, such as counselor, assistant, advisor, or receptionist, which constrains how the character should respond to a user.

The term “constraint conditions” refers to parameters or rules included in a prompt sentence that specify at least one of role, style, tone, or behavioral limits for a generative AI model when generating dialogue responses or content.

In one embodiment, a server cooperates with a terminal carried by a user to implement an emotion-aware content generation and presentation system. The server includes at least one processor, one or more memories, a network interface, and a non-transitory storage device. The terminal includes at least a processor, a memory, a camera module as an imaging device, a microphone, a touch-sensitive display, and a wireless communication interface.

The terminal uses the camera module, which may be implemented by a complementary metal-oxide-semiconductor image sensor and an optical lens system, together with an operating system camera framework such as an application programming interface for camera control, to capture image data including a face of the user. The terminal encodes the captured frames in a format such as JPEG or YUV and transmits selected frames to the server via a wireless network, using a transport protocol such as Hypertext Transfer Protocol Secure.

The server converts the received image data into pixel data by decoding the image into a two-dimensional array of numeric values, for example using an image processing library such as a general-purpose computer vision library. The server stores the pixel data in a matrix form in a main memory as a numerical array. The server then applies a face region detection learning model to the pixel data. In one example, the server uses a convolutional neural network trained on annotated face datasets, where the network has multiple convolutional layers, pooling layers, and fully connected layers, and outputs bounding boxes and confidence scores for detected face regions. The server may alternatively use a cascade classifier or other detection architecture.

The server normalizes the pixel values (for example, scaling them to a [0,1] or [−1,1] range) and resizes the image to a pre-defined resolution such as 224×224 pixels before inputting the data into the face region detection learning model. The server uses a predetermined threshold on the output confidence score to decide whether a candidate region constitutes a valid face region. This thresholding improves robustness against false positives and reduces downstream computation.

Once the server has specified at least one face region, the server extracts the corresponding sub-matrix from the pixel data and uses an expression analysis learning model to estimate an emotional state of the user. In one embodiment, the expression analysis learning model is a deep neural network implemented in a framework such as a general-purpose machine learning framework, and includes a stack of convolutional layers for extracting local facial features (e.g., eyebrow curvature, mouth shape, eye openness), a global pooling layer, and one or more fully connected layers that output a probability distribution over emotion categories. The server uses a softmax output layer to represent probabilities for each emotion label, such as joy, sadness, anger, surprise, fear, disgust, and neutral.

The server computes an emotion label by selecting the category with the highest probability and computes an emotion score as either the probability value itself or a normalized confidence score derived from the probabilities. By using the neural network to automatically learn abstract facial features from training data, the server achieves an improved classification accuracy compared to rule-based methods, and reduces the need for manually engineered features.

The server stores the emotion label and the emotion score together with a reference to the associated image in a structured record in the memory. The server also sends the emotion label and the emotion score to the terminal. The terminal uses this information to associate the emotional state with user input information.

The user provides input information through the input interface of the terminal. The user may type text using a software keyboard displayed on the touch-sensitive display, or speak into the microphone to provide audio input. The terminal can use a speech recognition library or service to convert audio signals into text. The terminal represents the recognized or typed text as a character string and may optionally associate metadata such as language code, timestamp, and the current application context (for example, “travel search screen” or “video recommendation screen”).

The terminal associates the user input information with the received emotion label and emotion score and generates structured data that contains all of these elements as separate fields. The terminal sends this structured data to the server. The server then generates a prompt sentence for a generative AI model. In one embodiment, the server uses a template-based construction where the server inserts the emotion label, emotion score, user input text, and optionally the intended role or style of an information-providing character into fixed phrase patterns.

The server generates the prompt sentence in natural language so that the generative AI model can interpret the emotional context and the user's intent. For example, the server may generate a prompt sentence such as:
“The user's emotion is ‘joy’. The user input is: ‘cheap flights to Hawaii’. Please generate a cheerful advertisement message for a travel campaign that matches the user's joyful mood.”

In another example, the server may generate:
“The user's emotion is ‘sadness’. The user input is: ‘I feel tired after work’. Please generate a gentle and comforting content suggestion, such as relaxing activities or wellness tips, using a kind and empathetic tone.”

In another example, the server may generate a prompt sentence including a character role constraint, such as:
“The user's emotion is ‘joy’. Please act as a friendly information-providing character and create an engaging introduction and three recommendations for movies or events that fit a joyful mood.”

By explicitly encoding emotion, context, and character role into the prompt sentence, the server enables the generative AI model to generate output conditioned on a rich, machine-usable description of the current interaction state.

The server sends the prompt sentence over a communication line to a generative information processing device that executes the generative AI model. The generative AI model may be implemented as a transformer-based neural network running on dedicated hardware such as graphic processing units or tensor processing units. The model uses a sequence of self-attention layers and feed-forward layers to encode the prompt sentence into internal vector representations and to generate a token sequence representing the output information.

The generative AI model is trained on large corpora of text using an objective such as next-token prediction with a cross-entropy loss function. During training, the model updates its weight parameters by gradient descent or a variant such as an adaptive optimizer. The model applies subword tokenization to handle diverse vocabularies and uses positional encodings to preserve word order. The model learns statistical patterns between language tokens and can generate fluent, context-sensitive content.

The server receives the generated output as text. The server can further parse or post-process the output to identify candidate messages. For example, the generative AI model may output three separate advertisement messages separated by delimiters. The server splits the text into distinct candidate messages and associates each candidate with tags such as length, sentiment intensity, or call-to-action strength. The server may also compute additional scores such as lexical diversity or sentiment consistency relative to the emotion label.

The server selects at least one candidate message using a selection algorithm that takes into account the emotion score and the operation history of the user. For example, the server may maintain statistics in the storage device indicating which types of messages the user has previously clicked or ignored. The server can compute a presentation priority function that increases the priority of candidate messages that historically correlate with higher engagement for similar emotion labels and contexts. By integrating emotion scores and operation history into the selection logic, the server improves the relevance and effectiveness of the presented content and reduces unnecessary network usage by avoiding the transmission of low-priority messages.

The server transmits the selected message or messages to the terminal, together with control information that specifies how an information-providing character should present the content. The control information may include parameters such as a desired facial expression type (e.g., “smile”), a tone descriptor for text-to-speech synthesis (e.g., “cheerful and energetic”), and layout preferences (e.g., “display in a speech bubble at the bottom of the screen”).

The terminal presents the message using an information-providing character. In one embodiment, the terminal renders a two-dimensional or three-dimensional avatar using a graphics framework or a game engine. The terminal maps the emotion label to a specific animation pattern or sprite set, such as a smiling face and open posture for joy, or a gentle, calm expression for sadness. The terminal displays the selected message as text near the character, and may also use a text-to-speech engine to synthesize audio speech that reads the message aloud with an appropriate prosody and speed. The terminal thereby controls both visual and auditory outputs of the information-providing character to align with the user's detected emotional state.

The user can interact with the presented content by tapping buttons, scrolling, or providing further text or voice input. The terminal records these interactions as operation history data, including identifiers of the presented messages, timestamps, and action types such as “clicked,” “ignored,” or “closed.” The terminal periodically sends this operation history to the server.

The server stores emotion labels, user input information, prompt sentences, generated content, and operation histories in a storage device as structured records. In one embodiment, the server uses a relational database management system and defines tables that link a user identifier (which may be anonymized), a session identifier, a timestamp, the emotion label and score, the input text, the prompt sentence, the generated candidate messages, the selected message, and the observed user actions. The server can perform batch analysis or online learning based on these records.

The server may adjust parameters of the face region detection learning model, the expression analysis learning model, and the generative AI model based on accumulated data. For example, the server can retrain or fine-tune the expression analysis learning model using additional labeled data to reduce classification errors for specific demographic groups or lighting conditions. The server can also use reinforcement learning or preference modeling to adapt the selection algorithm for candidate messages, using operation history as feedback. These adaptation mechanisms improve the technical performance of the overall system over time, resulting in higher emotion recognition accuracy, more relevant content generation, and improved user engagement metrics.

The system provides technical advantages beyond simple automation of human tasks. The server integrates multimodal sensor data (image and input text), machine-learned emotion estimation, structured prompt construction, and generative content selection into a unified data flow. Because the server uses a specific data structure for prompt sentences and an explicit control of the generative AI model via emotion and role constraints, the server reduces variability in generative outputs and improves predictability. This yields reduced processing time in subsequent filtering stages and lowers communication load by transmitting fewer irrelevant messages.

Moreover, the system improves computational efficiency by sharing intermediate representations. For instance, the server may reuse features computed by the face region detection learning model as input to the expression analysis learning model, avoiding redundant convolution operations. The server may also cache emotion labels for short time windows to avoid repeated inference when the user's expression remains stable, thereby reducing processor load and latency.

The system further improves data management by storing emotion-aware interaction logs in a structured and indexed format. This allows efficient retrieval for analysis and model updates, which in turn enhances the accuracy and efficiency of emotion detection and content selection. By tightly connecting low-level image processing, high-level emotion inference, structured prompt generation, and generative model control, the system improves the functioning of the underlying computer technology, including more efficient use of processor and network resources, higher classification accuracy, and reduced end-to-end response time in delivering emotion-tailored content.

In another embodiment, the server and the terminal can be implemented in different configurations. The face region detection learning model and the expression analysis learning model may run partially or entirely on the terminal when the terminal has sufficient computational resources, thus reducing communication latency and network usage. In this case, the terminal sends only the emotion label, emotion score, and user input information to the server, and the server focuses on prompt generation, generative AI interaction, candidate message selection, and data storage. Alternatively, the generative AI model may be executed on-premise by the server rather than in a remote generative information processing device, for scenarios requiring lower latency or stricter data control.

In another embodiment, the system can employ different neural network architectures such as residual networks, recurrent networks, or hybrid models for expression analysis, and can use different training strategies such as supervised learning with cross-entropy loss, metric learning with triplet loss, or semi-supervised learning using unlabeled images. The generative AI model may also be fine-tuned on domain-specific corpora, such as travel-related content or wellness-related content, to increase domain relevance.

In another embodiment, the prompt sentence generation logic may use rule-based post-processing to enforce safety or compliance constraints. For example, the server can automatically insert instructions into the prompt sentence such as “do not mention specific prices” or “avoid sensitive topics,” thereby constraining the generative AI model in a non-standard way that differs from human-only writing rules. These machine-specific constraints further improve the safety and consistency of the generated content and demonstrate that the system implements specialized computer processing rather than merely replicating human behavior.

Through these configurations and variations, the server and the terminal cooperate to implement a concrete, technically grounded pipeline that transforms raw sensor data and user input into controlled prompt sentences for a generative AI model and converts the model's outputs into optimized, emotion-aware presentations. This pipeline produces measurable improvements in processing speed, emotion detection accuracy, relevance and predictability of generated content, communication efficiency, and data management, thereby providing an improvement in computer technology itself.

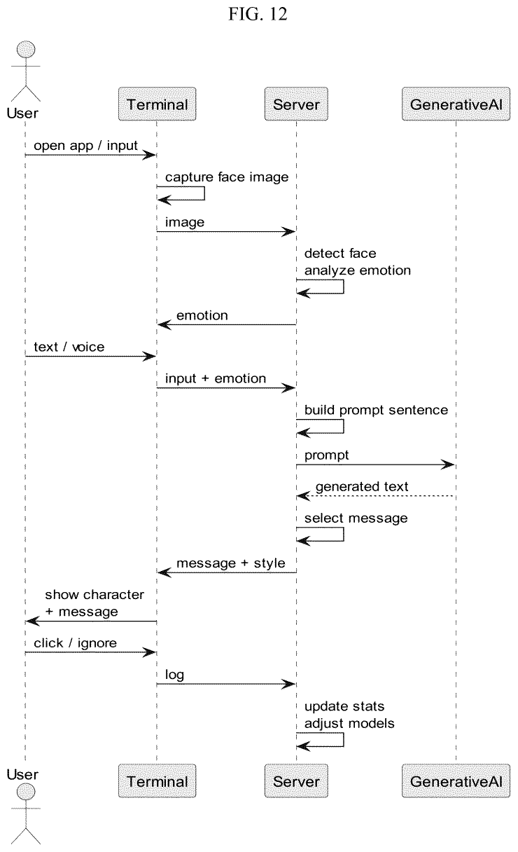

The following describes the processing flow using FIG. 12.

### Step 1:

The terminal activates a camera as an imaging device and acquires an image including the user's face. The terminal receives as input a trigger event (for example, the user opening an application screen) and camera control parameters from an application. The terminal calls an operating system camera API, starts a preview stream, and captures one or more frames of image data in a raw format such as YUV or a compressed format such as JPEG. The terminal outputs image data that contains pixel values representing the user's face region and surrounding background.

### Step 2:

The terminal selects a frame suitable for face analysis and sends it to the server. The terminal receives as input the sequence of captured frames from Step 1. The terminal may apply a lightweight on-device face presence check using a pre-installed vision library to verify that a face is visible. The terminal then compresses the selected frame to a JPEG image if needed, attaches metadata such as a timestamp and an anonymized user identifier, and packages the image in an HTTP request. The terminal outputs a network request containing the image data and metadata and transmits this request to the server over a secure communication channel.

### Step 3:

The server receives the image data and decodes it into pixel data. The server receives as input the HTTP request from Step 2, containing the JPEG-encoded image. The server uses a web application framework to parse the request and extract the binary image data. The server then invokes an image processing library to decode the JPEG into a two-dimensional array of pixel values, for example an array with dimensions (height, width, color_channels) stored in main memory as numeric types. The server outputs pixel data ready for further analysis.

### Step 4:

The server detects the user's face region in the pixel data using a face region detection learning model. The server receives as input the pixel data from Step 3. The server first normalizes the pixel values (for example, converting them from integer 0-255 to floating-point values in a normalized range) and resizes the image to a predefined resolution suitable for the detection model. The server feeds this processed pixel data into a trained detection model, such as a convolutional neural network or cascade classifier, which computes feature maps through convolution, pooling, and activation operations. The server identifies bounding boxes with confidence scores exceeding a threshold and selects the main face region (for example, the largest or highest-confidence box). The server outputs face region information, including bounding box coordinates and the cropped pixel data corresponding to the user's face.

### Step 5:

The server estimates the user's emotional state from the face region using an expression analysis learning model. The server receives as input the cropped face pixel data from Step 4. The server resizes the face region to a model-specific size, normalizes channels (for example, converting color space or subtracting mean values), and creates a tensor with a batch dimension. The server feeds this tensor into a trained deep neural network, such as a convolutional or residual network, which performs multiple layers of convolutions, non-linear activations, and pooling to produce a feature vector. The server applies a final fully connected layer and a softmax function to compute a probability distribution over predefined emotion categories. The server selects the category with the highest probability as an emotion label and may use the probability value as an emotion score. The server outputs the emotion label and emotion score as part of an emotion result.

### Step 6:

The server returns the emotion result to the terminal. The server receives as input the emotion label and emotion score computed in Step 5. The server formats these values into a structured response object, such as a JSON document containing fields for the emotion label, emotion score, and optional debugging information. The server sends this response over the existing HTTP connection back to the terminal. The server outputs a network response that the terminal can parse to obtain the user's current emotional state.

### Step 7:

The terminal associates the emotion result with the current user session. The terminal receives as input the emotion label and emotion score from Step 6. The terminal stores these values in a session data structure in local memory, possibly along with a timestamp and context identifiers such as the current screen name or content category. The terminal outputs an updated session state that includes the user's latest emotional state, which can be referenced when user input information is received.

### Step 8:

The user provides input information via the terminal's input interface. The user receives as input a visual or auditory prompt from the terminal, such as a search box or a dialogue window. The user then types text on the software keyboard, speaks into the microphone, or selects on-screen options. In the case of speech, the terminal uses a speech recognition component to convert audio waveforms into textual data by extracting acoustic features and matching them against a language model. The user outputs text input or selection information that the terminal records as user input information.

### Step 9:

The terminal structures the user input information together with the emotion result. The terminal receives as input the user input information from Step 8 and the emotion label and emotion score stored in the session state from Step 7. The terminal creates a structured record containing fields such as input_text, emotion_label, emotion_score, timestamp, and context identifiers. The terminal may also normalize or sanitize the input_text (for example, trimming whitespace, removing control characters). The terminal outputs a structured dataset that jointly represents the user's expressed intent and emotional state.

### Step 10:

The server generates a prompt sentence for a generative AI model based on the structured dataset. The server receives as input the structured dataset transmitted from the terminal after Step 9. The server selects a template according to the application context (for example, advertisement generation, recommendation, or counseling dialogue) and fills placeholders in the template with the actual values of emotion_label, emotion_score, and input_text. The server may also insert role or style constraints for an information-providing character. For example, the server constructs a prompt sentence such as: “The user's emotion is ‘joy’. The user input is: ‘comedy movies tonight’. Please generate three short, fun recommendations for comedy movies that match a joyful mood, each with a one-sentence description.” The server outputs a completed prompt sentence in natural language tailored for the generative AI model.

### Step 11:

The server sends the prompt sentence to the generative AI model and obtains generated content. The server receives as input the prompt sentence from Step 10. The server builds a request to a generative information processing device, which executes the generative AI model, and includes the prompt sentence and model parameters such as maximum output length and randomness level. The server transmits this request over a communication line to the external device. The generative AI model tokenizes the prompt into subword units, performs sequential self-attention and feed-forward computations on each token to derive contextual embeddings, and then generates output tokens by sampling from the model's predictive distribution at each time step. The generative AI model returns generated text containing one or more candidate messages, such as multiple advertisement options or recommendations. The server outputs the raw generated text from the generative AI model.

### Step 12:

The server parses the generated text and identifies candidate messages. The server receives as input the raw generated text from Step 11. The server applies text parsing rules, such as splitting on numbered list markers, line breaks, or predefined delimiters, to separate the text into discrete candidate messages. The server may compute heuristic features for each candidate message, such as length, presence of call-to-action phrases, sentiment polarity, or keyword coverage relative to the user input. The server outputs an array or list of candidate messages, each with associated features.

### Step 13:

The server selects a candidate message based on the emotion score and user operation history. The server receives as input the list of candidate messages with features from Step 12 and historical operation data for the user from a storage device. The server computes a presentation priority score for each candidate message using a scoring function that can combine factors such as the emotion score (for example, giving more weight to messages that are positively aligned with “joy” when the emotion label is “joy”), past click-through rates for similar messages, and diversity criteria to avoid repetition. The server then selects the candidate message with the highest presentation priority. The server outputs a selected message and associated control data indicating its priority and type.

### Step 14:

The server records interaction-related data for future optimization. The server receives as input the selected message, the emotion label and emotion score, the prompt sentence from Step 10, and identifiers for the user and session. The server constructs a log record that includes these values and initialization values for future operation history (for example, flags indicating that the message has been displayed but not yet clicked). The server writes this record into a storage device such as a database or log file. The server outputs a persistent log entry that can later be retrieved for analytics or model adjustment.

### Step 15:

The server transmits the selected message and presentation control information to the terminal. The server receives as input the selected message and any visual or auditory control parameters, such as the desired character expression and tone. The server embeds this information into a response object, for example containing fields “message_text,” “emotion_label,” “expression_type,” and “speech_tone.” The server sends this response to the terminal over the network. The server outputs a response packet that instructs the terminal how to display and voice the selected content.

### Step 16:

The terminal renders the information-providing character and displays the selected message. The terminal receives as input the response packet from Step 15. The terminal maps the emotion_label and expression_type to a specific avatar expression or animation sequence, such as a smiling face and enthusiastic gestures for joy. The terminal draws or animates the information-providing character on the display using a graphics framework and overlays or positions the message_text near the character. If speech_tone is provided, the terminal also calls a text-to-speech engine with parameters for pitch, speed, and style, synthesizes audio, and plays it through the speaker. The terminal outputs a combined visual and auditory presentation aligned with the user's detected emotional state.

### Step 17:

The user interacts with the presented content and the terminal records operation history. The user receives as input the displayed message and character presentation from Step 16. The user may tap on the message, press a “More details” button, dismiss the content, or provide new input. The terminal captures these actions as event records containing the message identifier, action type, and timestamp. The terminal aggregates these events into an operation history structure in memory. The terminal outputs operation history records that reflect the user's actual engagement with the generated content.

### Step 18:

The terminal sends operation history data to the server for analysis and model adjustment. The terminal receives as input the locally stored operation history accumulated in Step 17 and any pending log data. The terminal batches multiple events to minimize network overhead, packages them along with anonymized user and session identifiers, and transmits them to the server over the communication channel. The terminal outputs a network request that carries compressed or aggregated interaction data.

### Step 19:

The server updates stored logs and optionally adapts models or selection parameters. The server receives as input the operation history data from Step 18. The server locates the corresponding log records created in Step 14 using identifiers and updates fields such as “clicked,” “ignored,” “view_duration,” or “closed_early.” The server then computes statistics such as per-emotion click-through rates, average engagement for different prompt patterns, and error signals for emotion misclassification. Using these statistics, the server may schedule retraining or fine-tuning of the expression analysis learning model and adjust the candidate selection scoring function. The server outputs updated model parameters or configuration values that will influence future prompt generation and message selection, thereby closing the optimization loop for the emotion-aware generative AI content system.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional dialogue systems and counseling-type applications that utilize artificial intelligence often treat user input as flat text without robustly incorporating multi-modal cues such as facial expression, user identification, and conversation history into the response generation process. As a result, such systems frequently generate responses that are emotionally inappropriate, lack continuity with prior turns, or fail to provide a stable, personalized virtual character experience. In addition, many existing systems rely on static rule-based templates or shallow sentiment analysis that do not fully exploit modern generative AI models, thereby limiting the quality and adaptability of responses.

From the viewpoint of computer technology, there is a need for an improved server-side architecture and processing pipeline that (i) systematically combines user-specific biometric-derived information (for example, facial image-based identification and facial expression estimation) with text-based emotion analysis, (ii) structures this combined information into a machine-readable prompt sentence, and (iii) supplies the prompt sentence to a generative AI model in such a way that multi-turn, context-preserving, and emotion-appropriate dialogue can be generated in real time. Without such an architecture, computing resources of the generative AI model are not efficiently utilized, the dialogue quality is unstable, and it is difficult to implement a consistent virtual dialogue entity that behaves like a “window-type” character through which users can casually express daily dissatisfaction and anxiety.

Furthermore, conventional systems often do not provide a systematic mechanism to embed conversation history and behavioral policies of a virtual dialogue entity into the prompt sentence, which leads to fragmented conversations and inconsistent character behavior across multiple turns. This results in a technical problem in the field of computer-implemented dialogue systems: the inability of the server and processor to orchestrate biometric processing, natural language processing, prompt construction, and generative model control in an integrated manner that yields improved emotional alignment, continuity, and usability.

Accordingly, there is a demand for a computer-implemented technique that improves the internal operation of dialogue systems by defining how the processor (server) acquires and fuses multi-modal emotion information, generates structured prompt sentences containing control information and dialogue history, and controls a generative AI model to function as a consistent, emotionally aligned virtual dialogue entity, thereby enhancing the overall performance and technical effect of the dialogue system.

The specific processing by the specific processing unit 290 of the data processing device 12 in Example 2 is realized by the following means.

The present invention provides a server comprising a processor configured to acquire a facial image of a user by using an imaging function of an information processing terminal having an imaging function, perform individual identification processing and facial expression state estimation processing based on the acquired facial image, acquire input information expressed in natural language from the user, perform emotion state estimation processing on the input information by using natural language processing, integrate a result of the facial expression state estimation processing and a result of the emotion state estimation processing to determine an emotion state of the user, generate a prompt sentence, based on the emotion state of the user, the input information from the user, and role information of a virtual dialogue entity, the prompt sentence being for instructing a generative artificial intelligence model that performs generative natural language response processing to generate a dialogue-format response, configure the prompt sentence as input data to the generative artificial intelligence model, acquire the dialogue-format response output from the generative artificial intelligence model, transmit the dialogue-format response to the information processing terminal so that the dialogue-format response is displayed as a window-type dialogue screen of the virtual dialogue entity on the information processing terminal, record a plurality of dialogue histories between the user and the virtual dialogue entity, and include at least part of the dialogue histories in the prompt sentence, and further configured, in generating the prompt sentence, to attach control information including at least one of a response tone corresponding to the emotion state of the user, a constraint on response content, and a behavioral policy of the virtual dialogue entity, thereby controlling the generative artificial intelligence model to imitate at least one of personality, manner of speaking, and response style of an automatic response character that simulates a window-type character through which the user casually expresses dissatisfaction and anxiety regarding daily activities or work. This enables improved computer-implemented dialogue processing in which multi-modal user emotion information, conversation history, and character behavior policies are efficiently fused into structured prompt sentences, thereby allowing the generative artificial intelligence model to generate context-preserving, emotionally suitable natural language responses and to provide a consistent virtual dialogue entity, resulting in enhanced technical performance, stability, and usability of the server-based dialogue system.

The term “information processing terminal” refers to an electronic apparatus having at least a communication function, an input/output function, and an imaging function, the apparatus being configured to exchange data with a server and to present a dialogue screen to a user.

The term “imaging function” refers to a hardware and software capability of an electronic apparatus to capture still images or moving images, including at least one image sensor, lens system, and control circuitry, and a program for controlling acquisition and encoding of image data.

The term “facial image” refers to digital image data including at least a region corresponding to a user's face, the data being suitable for use in individual identification processing and facial expression state estimation processing.

The term “individual identification processing” refers to a processing operation in which biometric information derived from a facial image is compared with stored biometric information in order to determine or verify an identity of a user.

The term “facial expression state estimation processing” refers to a processing operation that analyzes a facial image to estimate an emotional or affective state of a user by detecting and classifying facial features associated with expressions such as happiness, sadness, anger, or fatigue.

The term “input information expressed in natural language” refers to character-string data or speech-recognized text that represents a user's utterance in a human language, such as sentences or phrases describing the user's thoughts, feelings, or situations.

The term “emotion state estimation processing” refers to a processing operation that analyzes natural language input information, and optionally other data, by using natural language processing techniques to determine an emotional state of a user, such as stress, anxiety, joy, or loneliness.

The term “virtual dialogue entity” refers to a software-implemented agent that behaves as a dialogue counterpart to a user, the agent having at least a defined role, personality, and manner of responding, and being presented to the user as a character or persona on a dialogue screen.

The term “role information of a virtual dialogue entity” refers to data defining at least one of a behavioral policy, personality profile, speaking style, and interaction objective of the virtual dialogue entity, the data being used in controlling how responses are generated.

The term “emotion state of the user” refers to an internal state label or representation computed by the system, indicating at least one of stress, anxiety, sadness, joy, tiredness, or similar affective conditions of the user, based on analysis of facial and/or textual information.

The term “prompt sentence” refers to structured text data supplied as input to a generative artificial intelligence model, the text data including at least instructions, context information, emotion information, and user input content that guide generation of a natural language response.

The term “generative artificial intelligence model” refers to a computational model that receives input data including at least a prompt sentence and outputs a sequence of natural language tokens, thereby generating a dialogue-format response according to learned statistical relationships.

The term “generative natural language response processing” refers to processing by which a generative artificial intelligence model produces new natural language text as an output based on a prompt sentence and optional additional context information.

The term “dialogue-format response” refers to a natural language text output that is structured as a turn in a conversation, the text being suitable to be displayed as a reply of the virtual dialogue entity to a user utterance.

The term “window-type dialogue screen” refers to a graphical user interface region in which exchanges between a user and a virtual dialogue entity are displayed in a conversational format, typically using message bubbles, character icons, and time-ordered message lists.

The term “dialogue histories” refers to recorded data representing past exchanges between a user and a virtual dialogue entity, including at least user messages, system responses, timestamps, and optionally associated emotion states or metadata.

The term “control information” refers to data appended to or embedded in a prompt sentence, the data specifying at least one of response tone, content constraints, safety requirements, and behavioral policy, and being used to control how a generative artificial intelligence model generates a response.

The term “response tone” refers to stylistic attributes of a generated response, such as politeness level, warmth, formality, or casualness, that influence how the response is perceived by the user.

The term “constraint on response content” refers to a rule or condition specifying allowable or prohibited topics, expressions, or types of advice in a generated response, in order to maintain safety, appropriateness, or compliance with predetermined guidelines.

The term “behavioral policy of the virtual dialogue entity” refers to a set of rules or preferences defining how the virtual dialogue entity should respond in various situations, including at least policies for empathy, encouragement, topic handling, and avoidance of certain types of guidance.

The term “automatic response character” refers to a virtual dialogue entity that automatically generates responses to user input by using a generative artificial intelligence model under control of prompt sentences, without requiring manual intervention by a human operator.

The term “window-type character” refers to a representation of a virtual dialogue entity designed to function as an approachable contact point, through which a user can casually express dissatisfaction, anxiety, or other feelings related to daily activities or work.

The term “multi-modal user emotion information” refers to combined emotion-related data derived from at least two modalities, including textual input and facial image information, the data being used for more accurate estimation of a user's emotional state.

The term “context-preserving response generation” refers to generation of natural language responses that take into account at least part of prior dialogue histories so that successive responses are coherent and consistent with previous turns in the conversation.

In one embodiment, a server cooperates with one or more terminals operated by users to implement a dialogue system that utilizes a generative AI model controlled by a structured prompt sentence. The system is configured so that the server executes computationally intensive processing, while each terminal handles user interaction, imaging, and presentation.

A terminal includes at least a processor, a memory, a display, an input interface, an imaging device such as a built-in camera, and a communication interface. The terminal operates under an operating system such as a mobile operating system or a general-purpose desktop operating system. The terminal presents a graphical dialogue interface, captures a facial image of a user through the imaging device, and transmits the captured image and natural-language input to the server over a secure communication channel, for example via HTTPS.

A server includes at least one processor, a main memory, a non-volatile storage device, a network interface, and an operating system. The server further includes program modules that implement: biometric processing including individual identification and facial expression estimation; natural language processing for emotion state estimation; prompt sentence generation for a generative AI model; invocation of the generative AI model; and management of dialogue histories. The server may be implemented by a general-purpose computing device, a cluster of computing devices, or a virtualized computing environment in a data center.

In one concrete configuration, the server executes an application layer implemented in a high-level language such as Python, running on an application framework such as a web framework. The server loads a face detection and recognition module that employs an image processing library (for example, a library with functions for image decoding, resizing, and color conversion) together with a deep neural network for embedding extraction, such as a convolutional neural network (CNN) model trained on facial images. The CNN may follow a residual network architecture having multiple convolutional layers, batch normalization layers, and residual connections. The model maps a cropped face image to an embedding vector in a high-dimensional space, for example a 128- or 512-dimensional feature vector. The server processes each facial image received from the terminal by decoding the image data into a pixel array, optionally converting the color space, and applying a face detector such as a Viola-Jones type classifier or a deep-learning-based region proposal network. The server normalizes the detected face region by aligning facial landmarks (for example, eyes and mouth corners) and resizing the region to a fixed resolution such as 160×160 pixels. The server then provides the normalized image to the CNN model to obtain an embedding vector. The server compares this embedding vector to reference embedding vectors stored in a user database by computing a similarity metric, such as cosine similarity or Euclidean distance. If the similarity exceeds a predetermined threshold, the server determines that the user has been successfully identified.

The server also executes a facial expression state estimation model. In one embodiment, the same or a different CNN architecture is used, trained on labeled facial expression datasets with classes such as neutral, happy, sad, angry, surprised, fearful, and tired. The CNN outputs logits for each emotion class, and the server applies a softmax function to obtain class probabilities. The server interprets the facial expression state as the class with the highest probability, optionally applying a threshold to handle low-confidence cases.

In parallel or subsequently, the server performs text-based emotion state estimation using a natural language processing model. In one embodiment, the server uses a transformer-based neural network architecture, such as a bidirectional encoder (similar to a transformer encoder) pre-trained on large-scale text corpora and fine-tuned on emotion classification data. The transformer model includes an embedding layer that maps tokens to vector representations, multiple self-attention layers that compute attention over token sequences, and feed-forward networks. The server tokenizes the user's input text into subword units, converts them to token identifiers, and constructs model inputs including token identifiers, position encodings, and attention masks. The server provides these inputs to the transformer model to obtain a sequence of hidden states and a pooled representation, typically the hidden state corresponding to a special classification token. The server feeds this pooled representation to a classification head, such as a fully connected layer followed by a softmax layer, to compute probabilities over emotion classes such as stress, sadness, joy, anger, loneliness, and similar states.

The server integrates the facial expression state estimation result and the text-based emotion state estimation result. In one example, the server represents each emotion result as a vector of probabilities over a shared emotion label set. The server computes a weighted sum of the two probability vectors, where a weight for the text-based result and a weight for the facial-based result are predetermined or dynamically adjusted based on confidence scores. The server then selects the emotion label with the highest combined probability as the emotion state of the user. This fusion of modalities enables improved accuracy compared to using only one modality, because inconsistencies such as neutral text but distressed facial expression can be resolved by considering both signals.

The server further maintains a dialogue history for each user. The dialogue history is stored in a structured format, for example as a table or document collection that includes fields for a user identifier, a turn index, a speaker flag (user or virtual dialogue entity), a message text, a timestamp, and one or more associated emotion states. In some variants, the dialogue history also stores the prompt sentences that were previously sent to the generative AI model and the responses returned. The server may limit the size of the history by maintaining only the most recent N turns or by compressing older turns into a summary.

Based on the current user input, the emotion state of the user, and the dialogue history, the server generates a prompt sentence for the generative AI model. Internally, the server uses a prompt template structure, which includes segments for: (i) a role description of the virtual dialogue entity; (ii) a description of the user's current emotion; (iii) selected dialogue history context; (iv) the current user message; and (v) control information specifying response tone, content constraints, and behavioral policy. The server concatenates these segments as a single text string, in a known programming language string format, to form the prompt sentence.

For example, the server may generate a prompt sentence such as:
“You are a gentle virtual window character who listens to the user's daily worries.
The user's detected emotion is: ‘stress’.
Recent conversation:
User: ‘Recently I am very stressed because work is too busy.’
Character: ‘That sounds really demanding. It is understandable to feel overwhelmed.’
Current user message: ‘I do not know how to relax after work.’
Please respond in English with empathy and in a supportive but concise tone. Acknowledge the user's stress and suggest a few simple, practical coping ideas. Avoid giving medical or legal advice.”

In another example, when the user expresses loneliness, the server may generate a prompt sentence such as:
“You are a warm, non-judgmental virtual window character who talks with the user about their daily feelings.
The user's emotion is: ‘lonely and sad’.
The user said: ‘I feel lonely lately and I don't know who to talk to.’
Please respond in English with a gentle, empathetic tone.
Acknowledge the user's loneliness, offer emotional support, and suggest one or two small, realistic actions that might help them feel a bit more connected.
Do not dismiss their feelings and do not provide professional medical advice.”

The server appends control information specifying a response tone (for example, warm, polite, casual), prohibited topics (for example, explicit medical diagnosis), and a behavioral policy (for example, prioritize empathy and validation before suggestions). These control parameters can be encoded as explicit instructions in the prompt text, or as metadata that is formatted into the prompt sentence in a structured manner. The inclusion of dialog history and control information in a single prompt sentence allows the generative AI model to produce responses that are both context-aware and constrained to behave according to the desired character profile.

The server then invokes a generative AI model. In one embodiment, the generative AI model is a transformer-based autoregressive language model deployed on a remote or local inference engine. The model includes an embedding layer, multiple transformer decoder layers with masked self-attention, and a language modeling head that outputs token probabilities. The server transmits the prompt sentence to the inference engine through an API, together with configuration parameters such as temperature, maximum output length, and sampling strategy (for example, top-k sampling or nucleus sampling). The server receives a generated response as a sequence of tokens which it decodes into a text string.

The generative AI model can be pre-trained on large-scale text corpora and further fine-tuned on dialogue datasets. During training, the model may use a cross-entropy loss function between predicted token distributions and ground-truth tokens, and weights are updated using stochastic gradient descent methods such as Adam. To improve robustness, the training process may include techniques such as dropout regularization, layer normalization, and data augmentation (for example, synonym replacement or noise injection in training text). While training of the model may occur offline, the structure and training method ensure that, during inference, the model can generate high-quality responses given the prompt sentence constructed by the server.

The server optionally includes additional logic for response filtering and safety. For example, the server can analyze the generated text using a separate classifier or rule-based filter to check for prohibited content or policy violations. If the generated text fails the check, the server can either discard the response and regenerate another response with stricter constraints, or modify the prompt sentence to emphasize the constraints and resubmit.

After obtaining an acceptable response, the server records the response in the dialogue history and transmits the response text to the terminal. The terminal receives the response and updates the dialogue interface. The terminal may display the response as a message bubble associated with a graphical representation of the virtual dialogue entity. The terminal may also adjust the avatar's facial expression or posture to reflect the detected emotion state or the content of the response. In some configurations, the terminal converts the response text into audio using a text-to-speech engine and plays it to the user.

A user reads or listens to the response and may then input another message, continuing the dialogue. The server repeatedly applies the processes described above, thereby maintaining a multi-turn conversation that is sensitive to the user's emotional state and to prior dialog context.

From a technical perspective, this architecture yields several improvements in computer technology. First, by fusing multi-modal user emotion information—specifically, biometric features derived from facial images and semantic features derived from text—the server improves the accuracy of emotion state estimation compared to systems based solely on one modality. The use of weighted probability fusion and thresholding rules enables the server to reduce classification errors caused by ambiguous expressions or texts. This improved accuracy directly affects the quality of subsequent prompt sentences and responses, producing more relevant and context-fitting outputs.

Second, the server structures the dialogue history and control information into a specific data format that is embedded into the prompt sentence. This design is distinct from generic logging of messages. By selecting only the most relevant recent turns and compressing older history, the server reduces the amount of data that must be transmitted to the generative AI model, thereby reducing communication load and improving response latency. At the same time, by including emotion labels and role information explicitly in the prompt sentence, the server causes the generative AI model to behave more consistently, which can reduce the need for repeated corrections and additional turns, further improving overall efficiency.

Third, the server implements specialized algorithms for prompt construction, rather than merely forwarding raw user text. For example, the server adopts non-conventional rules such as: always including the current emotion label with a standardized phrase, including only the last N turns where N is dynamically adjusted based on prompt length, and inserting explicit instructions about tone and constraints. These rules cause the generative AI model to generate responses that are better aligned with user needs, while also optimizing token usage and model context window. As a result, computational resources in the generative AI model are used more efficiently, leading to lower processing time and reduced memory consumption on the inference hardware.

Fourth, the integrated design of biometric identification and dialogue control on the server enables improved data management and security. Because the same embedding-based facial recognition module is used to authenticate the user at the time of dialogue, the server can correctly associate dialogue histories with user identities, preventing misattribution of emotional states or dialogue context. This reduces errors in subsequent prompt sentences where past conversation is referenced, leading to a more stable and accurate dialogue experience.

Fifth, the server's processing pipeline is not a simple automation of what a human counselor would do. The server utilizes high-dimensional embedding vectors, attention-based sequence modeling, and algorithmic fusion of emotion signals that would be impractical to implement manually in real time. The specific combination of neural network architectures, data structures for dialogue histories, and rule-based prompt composition results in a new way of performing dialogue management that is specific to computer systems. The system therefore improves the operation of the computer itself by optimizing how data is processed, stored, and transmitted to an inference engine.

Various alternative embodiments are possible. In one variant, the server omits facial expression state estimation and uses only text-based emotion state estimation, while still generating prompt sentences that embed emotion labels and dialogue history. In another variant, the server uses a different type of biometric modality, such as voice-based emotion recognition, instead of or in addition to facial images. In a further variant, the generative AI model is hosted locally on the same server hardware, and the server directly calls a local inference library instead of communicating with a remote service.

In another embodiment, the terminal executes part of the emotion analysis. For example, the terminal may run a lightweight on-device model for facial expression classification and send only the resulting emotion label to the server, thus reducing bandwidth usage. The server then fuses this on-device label with its own text-based emotion estimation and constructs the prompt sentence as described above. This division of labor can further improve efficiency in environments with constrained network capacity.

In yet another embodiment, the server uses different prompt templates depending on a detected usage scenario, such as daily stress, work-related issues, or social anxiety. The server may maintain a set of template variants, each specifying different control information and behavioral policies. The server selects an appropriate template based on the user's emotion state, keywords in the user's message, or prior interaction patterns. This modular template selection further refines the behavior of the virtual dialogue entity and can reduce the number of tokens needed in each prompt sentence by employing specialized, shorter instructions.

Through these embodiments, the system enables a concrete, technical implementation in which the server, terminal, and generative AI model cooperate to provide a multi-modal, emotion-aware dialogue service. By specifying particular data structures, neural network configurations, fusion algorithms, and prompt composition rules, the system provides more than an abstract idea of “counseling with AI” and instead discloses a specific improvement to the way computers perform dialogue processing, manage emotion-related data, and control the operation of a generative AI model.

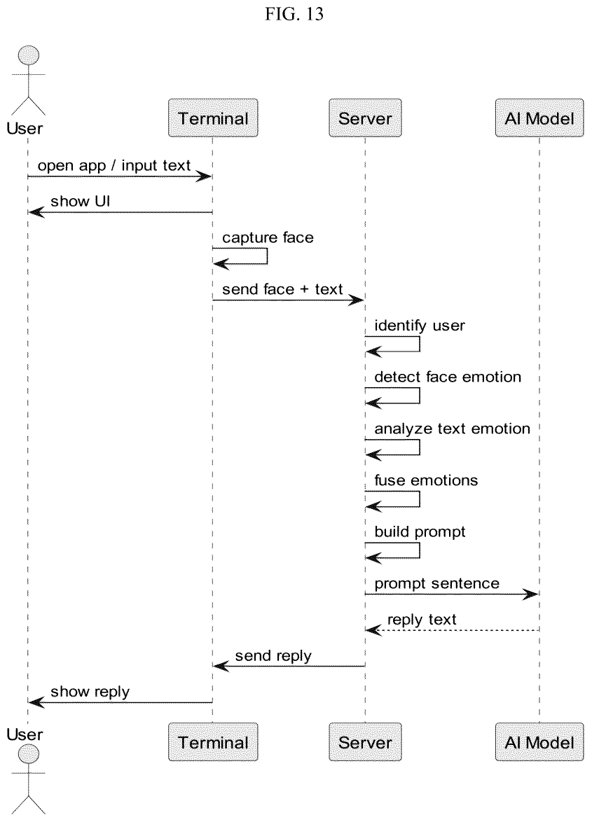

The following describes the processing flow using FIG. 13.

### Step 1:

User launches an application on the terminal and starts a dialogue session.
Terminal loads a dialogue user interface from a local storage into a memory and renders a chat screen including an input field, a send button, and a character avatar on a display.
Input: user action of starting the application.
Output: initialized dialogue screen ready to accept user input.

### Step 2:

Terminal activates an imaging device and acquires a facial image of the user.
Terminal calls an operating system camera API, controls exposure and focus, and captures one or more frames from the imaging sensor.
Terminal encodes the captured image into a compressed format such as JPEG, attaches session metadata (device ID, timestamp), and stores the encoded data in a memory buffer.
Input: raw image sensor data from the imaging device.
Output: encoded facial image data and associated metadata.

### Step 3:

Terminal transmits the encoded facial image data to the server for individual identification and facial expression estimation.
Terminal constructs a network request including the encoded image and session identifier, and sends it via HTTPS to a predetermined server endpoint.
Input: encoded facial image data and session identifier.
Output: network request containing the facial image transmitted to the server.

### Step 4:

Server receives the facial image and performs individual identification processing.
Server decodes the JPEG image to a pixel matrix, uses an image processing library to detect a face region, and extracts a normalized face crop by aligning facial landmarks and resizing the crop to a fixed resolution.
Server generates a facial embedding vector using a convolutional neural network for face recognition, and compares this embedding to stored embeddings in a user database using a similarity computation such as cosine similarity.
Based on similarity scores and a threshold, server determines a user identifier corresponding to the facial image or rejects the identification if no match is found.
Input: encoded facial image and session identifier.
Output: user identifier and an identification confidence score.

### Step 5:

Server performs facial expression state estimation using the normalized face crop.
Server applies a facial expression classifier implemented as a neural network to the face crop, computes logits for multiple emotion classes, and applies a softmax function to obtain probabilities for each class.
Server selects the class with the highest probability as the facial expression state, and records the probability distribution as an emotion confidence vector.
Input: normalized face image.
Output: facial expression label and facial emotion probability vector.

### Step 6:

User inputs a natural-language message into the terminal's input field and sends it.
Terminal receives keystrokes, constructs a text string in a specified character encoding, and displays the typed text in the chat interface.
When the user presses the send button, terminal packages the text with the current session identifier and user identifier (if available) into a data structure.
Input: user's natural-language text entry.
Output: text message data ready for transmission.

### Step 7:

Terminal transmits the user's text message to the server.
Terminal sends an HTTPS request containing the user identifier, session identifier, and the text message string to a server endpoint dedicated to dialogue messages.
Input: text message data, user identifier, session identifier.
Output: network request containing the user message transmitted to the server.

### Step 8:

Server receives the user message and stores it in a dialogue history.
Server validates the request, checks the user identifier, and normalizes the text (for example, trimming whitespace, converting to a standard Unicode form).
Server creates a dialogue record including fields such as user identifier, message text, timestamp, speaker flag (user), and optionally the session identifier, and inserts this record into a dialogue history storage.
Input: normalized text message, user identifier, timestamp.
Output: updated dialogue history including a new user turn record.

### Step 9:

Server performs text-based emotion state estimation on the user's message.
Server tokenizes the message text into subword units, maps these units to token indices, and creates attention masks.
Server feeds these token indices and attention masks into a transformer-based emotion classification model, obtains hidden states, and applies a classification head to produce logits for emotion classes.
Server applies a softmax function to convert logits into a probability distribution, and selects the class with the highest probability as the textual emotion state while keeping the full probability vector.
Input: user message text.
Output: textual emotion label and textual emotion probability vector.

### Step 10:

Server fuses the facial emotion information and the textual emotion information to determine a unified emotion state of the user.
Server aligns the emotion class sets for facial expression and textual estimation, and computes a weighted sum of the facial emotion probability vector and the textual emotion probability vector using predetermined weights.
Server identifies the emotion label with the highest value in the fused vector as the unified emotion state and computes an overall confidence score.
Input: facial emotion probability vector and textual emotion probability vector.
Output: unified emotion label and unified emotion probability vector.

### Step 11:

Server retrieves relevant dialogue history entries to construct context for prompt generation.
Server queries the dialogue history storage for recent turns associated with the same user identifier, sorts them by timestamp, and selects a subset of the most recent turns according to a maximum number or token limit.
Server extracts message texts and speaker flags from these records and builds a context string representing recent user and system exchanges.
Input: user identifier and dialogue history database.
Output: dialogue context string representing recent conversation history.

### Step 12:

Server generates a prompt sentence for the generative AI model based on the unified emotion state, current user message, dialogue context, and role information of a virtual dialogue entity.
Server prepares template segments including: a role description of the virtual dialogue entity, a textual description of the unified emotion state, a formatted representation of recent conversation, the current user message, and explicit control instructions specifying response tone, content constraints, and behavioral policies.
Server concatenates these segments into a single text string in a defined order, optionally inserting separators or markers, and designates this string as the prompt sentence.
Input: unified emotion label and probability vector, current user message, dialogue context string, and stored role information.
Output: constructed prompt sentence as a single text string.

### Step 13:

Server attaches control information to the prompt sentence to guide the generative AI model.
Server incorporates specific instructions indicating the desired style (for example, “gentle”, “supportive”), banned response categories (for example, “no medical diagnosis”), and character behavior rules (for example, “acknowledge feelings before suggesting actions”) as additional text lines within the prompt.
Server may adjust or refine these control instructions based on the unified emotion label or conversation state, updating the prompt sentence accordingly.
Input: base prompt sentence and control parameter set.
Output: finalized prompt sentence including embedded control information.

### Step 14:

Server invokes the generative AI model with the finalized prompt sentence.
Server sends the prompt sentence, along with generation parameters such as temperature, maximum token length, and sampling strategy, to a generative AI model inference endpoint over a network or local interface.
Server waits for the model to generate a response token sequence, then decodes the token sequence into a natural-language text response.
Input: finalized prompt sentence and generation parameters.
Output: generated dialogue-format response text.

### Step 15:

Server post-processes the generated response and updates the dialogue history.
Server analyzes the generated response for length and content, optionally applying a safety filter and simple sanitization such as trimming or splitting long paragraphs.
Server creates a new dialogue record with fields including user identifier, response text, timestamp, speaker flag (virtual dialogue entity), and optionally associated emotion state, and stores this record in the dialogue history storage.
Input: generated response text and user identifier.
Output: cleaned response text and updated dialogue history including a new system turn record.

### Step 16:

Server transmits the generated response to the terminal.
Server builds a response message including the generated text, a character identifier or avatar type, and optionally the unified emotion label as metadata, and sends this message via HTTPS to the terminal that initiated the request.
Input: cleaned response text and presentation metadata.
Output: network response containing the virtual dialogue entity's reply delivered to the terminal.

### Step 17:

Terminal receives and displays the generated response to the user.
Terminal parses the network response, extracts the response text and associated metadata, and appends a new message bubble to the chat interface representing the virtual dialogue entity's turn.
Terminal may update the avatar's expression based on the unified emotion label, and scroll the display so that the latest message is visible to the user.
Input: network response containing response text and metadata.
Output: updated dialogue screen showing the character's response.

### Step 18:

Terminal optionally converts the generated response text into audio and plays it.
Terminal checks user settings, and if voice output is enabled, invokes a text-to-speech engine with the response text and a selected voice profile.
Terminal receives audio data from the text-to-speech engine and outputs it through speakers or headphones, synchronized with the displayed message.
Input: generated response text and text-to-speech configuration.
Output: audio playback of the virtual dialogue entity's response.

### Step 19:

User views or listens to the response and decides whether to continue the conversation.
User interprets the content and emotional tone of the response, and, if desired, composes another natural-language message in the input field on the terminal.
This subsequent message becomes the new input for the next cycle of processing, and the entire sequence from message acquisition to response generation is repeated.
Input: displayed or spoken response.
Output: subsequent user action in the form of a new text input or termination of the session.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional dialogue systems and customer-support systems generally treat user input as static text or, at most, as isolated audio or image data, and therefore fail to capture and utilize the rich, time-varying emotional state of a user in a systematic way. As a result, conventional systems often produce generic or mismatched responses that do not adequately reflect the user's current emotional context, leading to reduced user satisfaction and, in a retail setting, inconsistent quality of service across attendants.

In particular, existing architectures typically pass raw or minimally processed sensor inputs directly to an application or to a generative AI model without providing an intermediate layer that: (i) fuses multimodal features (facial expression, voice characteristics, and textual content), (ii) explicitly estimates an emotional state, (iii) accumulates and learns user-specific emotional patterns over time, and (iv) dynamically adapts the construction of prompt sentences supplied to a generative AI model. This lack of structured, emotion-aware pre-processing means that the downstream generative AI model is under-informed, and improvements in user experience rely mainly on manual prompt tuning or heuristic rules, rather than on a systematic computational mechanism integrated into the platform.

Moreover, conventional systems do not provide a stable, reusable control framework by which a processor can automatically modify prompt sentences and response-presentation behavior based on learned emotional histories, device form factors (for example, wearable or portable displays), and application context (for example, counseling versus in-store assistance). In the absence of such a framework, the processing logic becomes fragmented across application code, making it difficult to ensure predictable behavior, to scale to multiple devices and use-cases, or to verify and maintain the system.

Accordingly, there is a need for a computer-implemented system and server architecture that improve the functioning of the dialogue platform itself by introducing dedicated processing units configured to: (i) acquire and transform multimodal sensor data into structured emotional-state information, (ii) maintain and update emotion histories as a machine-readable resource, (iii) generate prompt sentences for a generative AI model in a manner that is explicitly conditioned on the current emotional state and its history, and (iv) control the presentation of responses on various display devices in a way that is automatically adapted to the user's emotional context and to past system outcomes. By embedding these operations into the processor's configuration, the overall computing system can more efficiently allocate processing across modules, reduce redundant or ad hoc computations in application layers, and achieve more consistent, context-appropriate dialogue behavior.

The specific processing by the specific processing unit 290 of the data processing device 12 in Application Example 2 is realized by the following means.

The present invention provides a server comprising a processor configured to acquire, via an image acquisition device, facial images of a subject and transform the images into facial feature data suitable for expression analysis; to acquire, via an audio acquisition device, audio signals of the subject and transform the audio signals into utterance-content data and acoustic feature data; to estimate, by executing an emotion estimation unit, an emotional state on the basis of at least the facial feature data, the acoustic feature data, and user input information; to maintain, in a storage unit, history information of the emotional state associated with a user or a session; to construct, by executing a prompt generation unit, a prompt sentence for instructing a generative AI model to generate a response, the prompt sentence being explicitly conditioned on the estimated emotional state, the user input information, and context information relating to a dialogue situation; to execute a learning control unit that learns user-specific emotion patterns based on the prompt sentence and the history information of the emotional state, and that updates a construction policy used by the prompt generation unit for subsequent prompt sentences; to input the constructed prompt sentence to the generative AI model and obtain, via a response acquisition unit, a dialogue-type response generated by the generative AI model; and to convert, by executing a response presentation control unit, the obtained dialogue-type response and the estimated emotional state into display information adapted to at least one of a wearable display device for an attendant and a portable display device for a user. This enables the computing system to implement an integrated, emotion-aware dialog control pipeline in which multimodal sensor data are systematically transformed into emotional-state representations, prompt sentences for the generative AI model are dynamically optimized based on current and historical emotional patterns, and generated responses are automatically tailored and rendered according to device type and user context, thereby improving the technical functioning, consistency, and efficiency of the underlying dialogue platform.

The term “image acquisition device” refers to a hardware device configured to capture image data of a subject, such as a camera, an imaging sensor, or an imaging module integrated in a computing device.

The term “facial image” refers to image data in which at least a part of a subject's face is included and is suitable for detection of a face region and analysis of facial expressions.

The term “face region detection” refers to processing that locates, within a facial image, a region corresponding to a subject's face by using an algorithm such as a pattern recognition method, a machine learning model, or a rule-based detector.

The term “facial feature extraction” refers to processing that derives numerical or symbolic data representing characteristics of a subject's face, including at least one of landmark positions, contours, or texture features, from a facial image.

The term “facial feature data” refers to structured data representing characteristics of a subject's face obtained by facial feature extraction, and used as input for expression analysis or emotion estimation.

The term “expression analysis” refers to processing that interprets facial feature data to determine a facial expression category or an intermediate representation useful for estimating an emotional state.

The term “audio acquisition device” refers to a hardware device configured to capture audio signals, such as a microphone, a microphone array, or an audio input module integrated in a computing device.

The term “audio signal” refers to time-series data representing sound, including at least the voice of a subject, in an analog or digital form.

The term “speech recognition” refers to processing that converts an audio signal containing speech into textual data representing the linguistic content of the speech.

The term “acoustic feature extraction” refers to processing that derives numerical data representing characteristics of an audio signal, including at least one of pitch, energy, spectral shape, and speaking rate.

The term “utterance content data” refers to textual data or structured linguistic data representing the content of speech obtained from an audio signal by speech recognition.

The term “acoustic feature data” refers to structured data representing acoustic characteristics of an audio signal obtained by acoustic feature extraction, and used as input for emotion estimation or paralinguistic analysis.

The term “user input information” refers to information explicitly provided by a user, including at least one of text input, voice input, selection input, or other operation data entered through a terminal.

The term “emotion estimation unit” refers to a functional module implemented by software, hardware, or a combination thereof, configured to estimate an emotional state of a subject on the basis of at least facial feature data, acoustic feature data, and user input information.

The term “emotional state” refers to data representing an inferred affective condition of a subject, including at least one of discrete emotion categories, dimensional emotion values, confidence scores, or related attributes.

The term “history information of the emotional state” refers to stored data representing one or more past emotional states associated with a particular subject, session, or interaction context over time.

The term “context information relating to a dialogue situation” refers to data that describe circumstances of an interaction, including at least one of application type, role of a counterparty, device type, location category, or prior dialogue events.

The term “prompt sentence” refers to a sequence of symbols, typically in natural language, constructed to instruct a generative AI model regarding how to generate a response, and including at least information about user input and an emotional state.

The term “prompt generation unit” refers to a functional module implemented by software, hardware, or a combination thereof, configured to construct a prompt sentence on the basis of at least an emotional state, user input information, and context information.

The term “construction policy of the prompt sentence” refers to a set of rules, parameters, or learned models that determine how information is arranged, weighted, or expressed when forming a prompt sentence for a generative AI model.

The term “learning control unit” refers to a functional module implemented by software, hardware, or a combination thereof, configured to learn user-specific emotion patterns from history information of the emotional state and to update a construction policy used by the prompt generation unit.

The term “user-specific emotion pattern” refers to data or a model representing tendencies or regularities in a particular user's emotional states over time, optionally conditioned on topics, situations, or interaction outcomes.

The term “generative artificial intelligence model” refers to a computational model, typically a machine learning model such as a neural network, configured to generate output data, including natural-language text, in response to input data such as a prompt sentence.

The term “response acquisition unit” refers to a functional module implemented by software, hardware, or a combination thereof, configured to input a prompt sentence to a generative artificial intelligence model and to obtain a generated response from the model.

The term “dialogue-type response” refers to response data generated by a generative artificial intelligence model that is formatted or structured to emulate conversational utterances in a dialogue.

The term “response presentation control unit” refers to a functional module implemented by software, hardware, or a combination thereof, configured to convert a dialogue-type response and an emotional state into display information suitable for presentation on one or more display devices.

The term “display information” refers to data formatted for presentation to a human via at least one output device, including at least text, graphics, or control hints adapted to a particular display device.

The term “wearable display device” refers to a display apparatus configured to be worn on a body part of a user or an attendant, including at least head-mounted displays, smart glasses, or wrist-mounted displays.

The term “portable display device” refers to a display apparatus configured to be carried and operated by a user, including at least handheld terminals, mobile terminals, or tablet-type terminals.

The term “attendant” refers to a human operator, such as a clerk or staff member, who provides services or responses to another person based on guidance presented by the system.

The term “user” refers to a human individual who interacts with the system by providing input information and receiving responses via at least one terminal or display device.

The term “virtual dialogue agent” refers to a software-controlled dialogue entity, represented by text, graphics, animation, or synthetic speech, that interacts with a user in a conversation using responses generated by a generative artificial intelligence model.

The term “speaking style” refers to characteristics of wording and tone in a generated response, including at least politeness level, formality, emotional nuance, and interaction manner.

The term “response length” refers to at least one of the amount of textual content, number of dialogue turns, or duration of audio output constituting a generated response.

The term “specificity level of advice” refers to a degree of concreteness or detail in guidance or suggestions contained in a generated response, including whether actions are described in general terms or as explicit, stepwise instructions.

The term “dialogue history” refers to stored data representing past exchanges between a user and a system or virtual dialogue agent, including at least previous user inputs, system responses, and associated emotional states.

In one or more embodiments, a server, a terminal, and a user cooperate to implement a system that acquires multimodal data, estimates an emotional state, generates a prompt sentence for a generative AI model, and presents a dialogue-type response on a display device in a manner that is technically optimized for the emotional context and device characteristics.

### A. Overall Hardware and Software Configuration

Server comprises one or more processors, a memory, a storage device, and a communication interface. Server is implemented, for example, as a rack-mounted information processing apparatus equipped with a multi-core central processing unit (CPU), an optional graphics processing unit (GPU) for neural network inference, and a network interface supporting wired or wireless communication. Server executes an operating system such as a general-purpose server operating system and runs application programs implementing an emotion estimation unit, a prompt generation unit, a learning control unit, a response acquisition unit, and a response presentation control unit.

Terminal comprises at least one processor, a memory, a display device, an image acquisition device, and optionally an audio acquisition device. Terminal is implemented, for example, as a smartphone, a tablet, or a head-mounted display device such as smart glasses. Terminal executes an operating system such as a mobile operating system and runs an application for capturing images and audio, displaying dialogue-type responses, and transmitting data to server via a communication network.

User operates terminal to initiate an interaction. User allows terminal to capture a facial image via the built-in camera and, in some embodiments, provides voice input via a microphone. User also enters text input through a touch screen or a keyboard on terminal. Server, terminal, and external services communicate via a network. The network includes wired or wireless links, and server and terminal exchange data using secure transport protocols such as an encrypted hypertext transfer protocol.

In one embodiment, server uses general-purpose libraries and frameworks, such as an image processing library (for example, an open-source computer vision library), a face landmark extraction library (for example, a general landmark detection framework), a speech recognition library (for example, a general speech-to-text toolkit), and a deep-learning framework (for example, a tensor-based computation framework) to implement the described functions. A generative AI model is implemented as a large-scale neural network deployed on server or on a cloud-based inference service accessible to server via an application programming interface.

### B. Multimodal Feature Extraction and Emotion Estimation

Server receives a facial image from terminal. Terminal uses its image acquisition device to capture the facial image at a defined resolution and encodes the image, for example as a compressed format. Terminal transmits the encoded image to server through the communication interface.

Server decodes the received image into an in-memory array. Server applies a face region detection algorithm implemented using an image processing library. In one embodiment, server uses a cascade classifier or a deep convolutional neural network (CNN) to detect a bounding box corresponding to the face region. Server then uses a landmark detection library such as a generic facial landmark detector to extract coordinates of key facial points (for example, corners of the eyes, mouth, and eyebrows). Server normalizes these coordinates by translating and scaling them so that they are invariant to image size and distance. Server concatenates the normalized coordinates into a facial feature vector. This facial feature vector serves as facial feature data.

Server also receives an audio signal from terminal when voice input is available. Terminal uses its audio acquisition device, such as a built-in microphone, to capture voice at a predetermined sampling rate and encodes the signal as a compressed audio stream. Server decodes the audio stream into raw audio samples. Server executes a speech recognition library to obtain utterance content data, which is a text string representing the spoken content. Server also computes acoustic feature data from the audio signal. For example, server uses a signal-processing library to extract mel-frequency cepstral coefficients (MFCCs), pitch contours, short-time energy, and speaking rate. These acoustic features are represented as a feature vector or a sequence of vectors.

Server implements the emotion estimation unit as a neural network model that receives facial feature data, acoustic feature data, and optionally user input information as inputs. In one embodiment, the emotion estimation unit is a multi-layer neural network with at least one branch for visual features and one branch for acoustic features. The visual branch uses a stack of fully connected layers with non-linear activation functions to process the facial feature vector. The acoustic branch uses either a recurrent neural network (RNN), a temporal convolutional network (TCN), or a transformer encoder to process the sequence of acoustic feature vectors. Server concatenates the outputs of the visual and acoustic branches, optionally with an embedding of user input information (for example, a sentence embedding produced by a small language model). Server then applies additional fully connected layers to produce a probability distribution over discrete emotion classes (for example, joy, anger, sadness, surprise, neutral, dissatisfaction). Server uses a softmax layer to obtain normalized probabilities and selects the emotion class with the highest probability as the emotional state. Server may also output a continuous representation such as valence and arousal values. During training of the emotion estimation unit, server uses a supervised learning approach. Server stores labeled training data in storage, where each training sample includes facial feature data, acoustic feature data, and a ground-truth emotion label. Server initializes the neural network parameters randomly or using pre-trained weights and iteratively updates the parameters using an optimization algorithm such as stochastic gradient descent or Adam. Server computes a loss function such as categorical cross-entropy between the predicted emotion distribution and the true label distribution. Server computes gradients of the loss with respect to the weights using backpropagation and updates the weights to reduce the loss. Server may apply regularization techniques such as dropout, weight decay, and data augmentation (for example, random cropping or horizontal flipping of face images, additive noise in audio signals) to improve generalization.

By representing emotional state as structured data derived from combined facial and acoustic features, server creates an internal data structure that conventional text-only dialogue systems do not maintain. This structured emotional state enables downstream modules to systematically adapt their behavior. Because the emotion estimation unit uses multi-branch neural architectures and engineered features, server can achieve improved accuracy and robustness over systems that rely only on a single modality or on simple heuristic rules.

### C. Emotion History and Learning Control

Server stores for each user or session the estimated emotional states as history information. Server uses a database or structured storage to maintain a time-ordered list of emotional states, along with associated metadata such as timestamps, topics, and outcomes of past interactions. Each record includes at least the emotion label, confidence score, and context flag (for example, counseling mode, retail mode).

Server implements the learning control unit as a module that reads the history information and learns user-specific emotion patterns. In one embodiment, server uses a recurrent neural network, such as a gated recurrent unit (GRU) or long short-term memory (LSTM) network, to process the sequence of past emotional states and to output a user-specific embedding vector. This embedding captures tendencies such as “user frequently becomes angry when discussing work” or “user often shows anxiety late in the evening.”

Server trains the learning control unit using historical logs, with an objective to predict future emotional shifts or to minimize a discrepancy between predicted and observed emotional states. Server uses a loss function such as mean squared error for predicted continuous emotion values or cross-entropy for predicted discrete emotion categories. Server updates the weights of the learning control network by gradient descent and stores the final network parameters in memory.

Server, at runtime, uses the learning control unit to generate a user-specific embedding when new history information is available. This user-specific embedding is used by the prompt generation unit to adjust a construction policy for prompt sentences. For example, if the history indicates repeated anger when responses are too brief, the construction policy is updated to increase the default response length and empathetic phrasing for that user. This adaptive adjustment is based on algorithmic rules encoded in the learning control unit, rather than being manually configured, and therefore represents a technical improvement in how prompt sentences are automatically optimized.

### D. Prompt Generation and Generative AI Model Interaction

Server implements the prompt generation unit as a rule-based and model-based component that constructs a prompt sentence for a generative AI model. Server inputs the currently estimated emotional state, the user input information, the context information (for example, “retail assistance” or “emotional counseling”), and the user-specific embedding produced by the learning control unit.

Server maintains a template library for prompt sentences. Each template specifies where to insert emotional descriptors, context labels, and user input text. The learning control unit provides numeric parameters such as an empathy weight, a specificity level, and a verbosity level. Server uses these parameters to select or modify templates. For example, when the empathy weight is high, the template includes explicit instructions such as “Respond with strong empathy and reassurance.” When the specificity level is high, the template includes instructions such as “Provide at least two concrete actionable steps.”

Server then constructs a prompt sentence by combining the selected template with the current emotional state and user input. In one exemplary retail scenario, server constructs the following prompt sentence:
“Customer is showing an angry facial expression and raised voice while complaining about a defective product in a store. The transcribed statement is: ‘This thing broke after just one day!’ Act as a polite store clerk. Propose specific phrases and actions that the clerk should take to calm the customer, apologize appropriately, and offer a realistic solution. Generate the response in a dialogue style.”

In another counseling scenario, server constructs the following prompt sentence:
“User's facial expression and previous history indicate fatigue and stress. The user wrote: ‘I am really tired of my work today.’ Act as a supportive counselor. Respond with empathy, acknowledge the user's feelings, and suggest one or two simple ways to unwind today, using a gentle and calm tone.”

These prompt sentences are not static, but are automatically adapted based on the user-specific embedding and the context parameters. Because server uses explicit numeric controls (for example, empathy weight, specificity level) to adjust templates, the generation process is reproducible, machine-controlled, and optimized for the generative AI model's behavior. This differs from purely manual prompt engineering and constitutes a technical mechanism that improves the quality and consistency of model outputs.

Server then transmits the constructed prompt sentence to a generative AI model. The generative AI model is implemented as a large-scale neural network, for example a transformer-based language model with multiple self-attention layers and feedforward layers. The model receives the prompt sentence as a sequence of tokens and computes internal representations by performing matrix multiplications and attention-weighted aggregations at each layer. The model outputs a sequence of tokens forming a dialogue-type response. Server, via the response acquisition unit, receives this response string.

In some embodiments, server hosts the generative AI model locally using a deep-learning framework and inference-optimized hardware such as GPUs. In other embodiments, server uses an external inference service accessible through an application programming interface. In both cases, server uses controlled token limits, temperature parameters, and stopping criteria to manage computation time and output length. This yields an improvement in processing efficiency and resource utilization.

### E. Response Presentation and Device Adaptation

Server implements the response presentation control unit to adapt the obtained dialogue-type response to different device form factors. When the device is a wearable display device used by an attendant, server extracts the key action phrases from the response, for example using a simple pattern-matching or syntactic parsing method, and composes a compact instruction set. Server generates display information such as:
“Calmly apologize for the inconvenience, explain the exchange/refund options, and thank the customer for the feedback.”

Server transmits this compact instruction set to terminal, which displays the instructions in a concise overlay on a head-mounted display. This improves usability in environments where screen space and reading time are limited.

When the device is a portable display device used directly by user, server may transmit a fuller, more conversational response. Terminal displays this response in a chat-like interface, with user messages and AI messages presented in chronological order. Terminal may also render a virtual dialogue agent as an avatar whose facial expression and speech are synchronized with the textual response, using local animation and text-to-speech software. Server stores the full response and the compact display information in a conversation log, together with the emotional state, the prompt sentence used, and any user feedback such as rating signals. Server can later use this log to further refine the learning control unit and prompt generation unit.

### F. Technical Advantages and Computer-Technology Improvements

This architecture provides several technical effects beyond mere automation of human tasks. Because server constructs and updates explicit data structures for emotional states and emotional histories, and because server uses these structures to control prompt sentence formation and device-specific rendering, the system improves the functioning of the dialogue platform itself.

First, by fusing visual and acoustic features through an emotion estimation unit with a dedicated neural architecture, server achieves higher emotion recognition accuracy and robustness than a system that only uses text-based sentiment analysis. Accurate emotional state estimation reduces the number of mismatched responses, thereby lowering the error rate in generated guidance.

Second, by recording history information of emotional states and by computing a user-specific embedding through the learning control unit, server reduces the need to recompute or rediscover emotional patterns for every new interaction. This reuse of historical information improves computational efficiency and reduces the number of calls to large models needed to achieve a satisfactory response, thereby decreasing computational load and latency.

Third, by parameterizing the prompt generation unit with numeric controls such as empathy weight and specificity level, and by aligning those parameters with learned emotional patterns, server systematically optimizes prompt sentences so that the generative AI model can operate in a more constrained and relevant context. This targeted prompting reduces the length and complexity of prompts compared to generic or manually crafted text, thereby reducing token counts sent to the generative AI model and lowering communication and inference costs.

Fourth, by implementing a response presentation control unit that transforms the same dialogue-type output into device-appropriate display information, server reduces the need for separate application logic on each terminal. For example, wearable devices receive short imperative instructions, while handheld devices receive full conversational responses. This centralized adaptation logic reduces inconsistencies, simplifies client implementations, and contributes to reduced overall system maintenance costs.

Fifth, by training the emotion estimation unit and learning control unit with explicit loss functions and weight updates, and by employing data augmentation and regularization, server improves generalization and reduces overfitting. As a consequence, the system can maintain high performance even under varying lighting conditions, microphone qualities, and user populations.

### G. Variations and Alternative Embodiments

Server, in some embodiments, may omit acoustic processing and operate solely on facial images and text. In such cases, server still constructs facial feature data and uses the emotion estimation unit to estimate an emotional state based on only visual features and user input information. The remaining components, namely the prompt generation unit, learning control unit, response acquisition unit, and response presentation control unit, operate substantially as described.

In other embodiments, terminal executes part of the processing locally. For example, terminal may run a lightweight emotion estimation unit that classifies coarse-grained emotions on-device, thereby reducing bandwidth by transmitting only feature vectors or emotion labels rather than full-resolution images and audio. Server then refines the emotional state using more sophisticated models. This division of labor further reduces overall communication load and processing latency, especially in resource-constrained networks.

In another variation, server may use different neural architectures for the emotion estimation unit and the learning control unit, such as transformer encoders for long emotion histories or graph neural networks for representing interactions among multiple users and attendants. In each case, server still uses structured emotional state data to guide prompt generation and response presentation, preserving the core technical concept.

In yet another embodiment, server integrates an external face analysis service or an external speech analysis service as part of the emotion estimation unit. Server preprocesses input data, sends anonymized features to the service, and receives intermediate emotion indicators. Server then combines these indicators with locally computed features in a hybrid model, thereby improving accuracy while retaining control over history information and prompt generation.

In summary, server, terminal, and user cooperate in a specific architecture that transforms raw multimodal data into structured emotional states, uses a learning control unit to derive user-specific emotion patterns, generates optimized prompt sentences for a generative AI model, and renders device-appropriate responses. This architecture provides concrete improvements in accuracy, efficiency, and behavior predictability of computer-based dialogue systems, and can be implemented with widely available hardware and software components as described above.

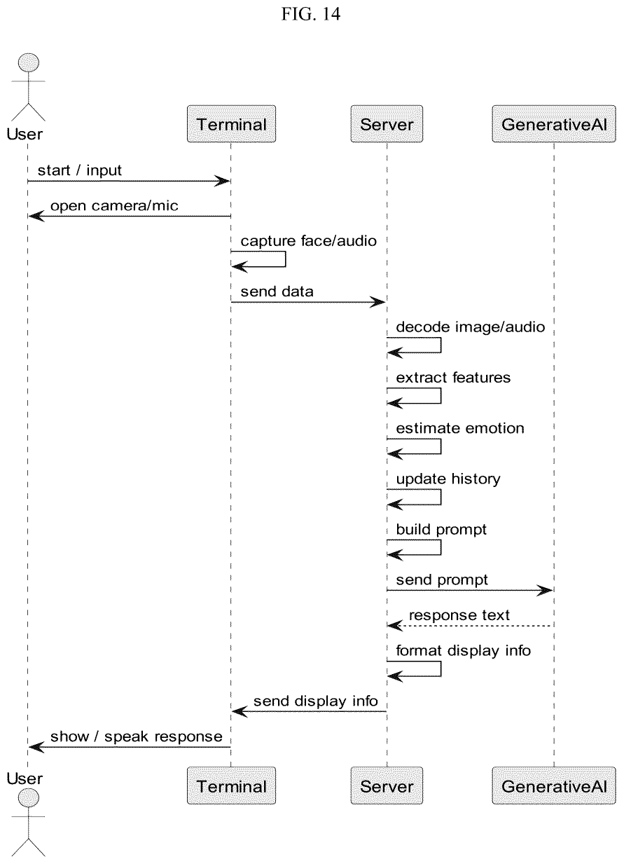

The following describes the processing flow using FIG. 14.

### Step 1:

User operates the terminal to start an interaction.
User launches an application on the terminal and allows access to the camera and microphone, and optionally inputs initial text such as a question or complaint. The input is the user's physical actions (tap, click, voice) and optional initial text. The output is an internal session context on the terminal, including a session identifier and flags indicating which sensors (camera, microphone) are active.

### Step 2:

Terminal captures a facial image of the user.
Terminal activates its image acquisition device (for example, a built-in camera) and captures one or more frames of the user's face at a predetermined resolution (for example, 1280×720 pixels). The input is the optical image projected onto the camera sensor. The terminal converts the sensor data into digital image data and compresses it (for example, into a JPEG file). The output is compressed facial image data associated with the current session identifier.

### Step 3:

Terminal captures an audio signal of the user.
Terminal activates its audio acquisition device (for example, a built-in microphone) and records the user's speech at a sampling rate such as 16 kHz. The input is the acoustic pressure waveform generated by the user's voice. The terminal converts this waveform into digital audio samples and encodes them (for example, into a compressed audio format). The output is compressed audio data corresponding to the user's utterance, tagged with the session identifier and timestamps.

### Step 4:

Terminal transmits captured data and user input information to the server.
Terminal bundles the compressed facial image data, the compressed audio data, and any text typed by the user into a structured request, and sends this request to the server over a secure communication protocol. The input is the locally stored multimodal data and user text. The terminal performs data packaging and encryption operations, and the output is a network message containing the multimodal data that is transmitted to the server.

### Step 5:

Server receives and decodes the facial image.
Server accepts the network message and extracts the compressed facial image data. The input is the compressed image data stream. Server decodes the image using an image processing library, converting the compressed bytes into a two-dimensional array of pixel values in a standard color space. The output is a decoded facial image matrix stored in server memory for further analysis.

### Step 6:

Server performs face region detection and facial feature extraction.
Server applies a face detection algorithm to the decoded facial image to locate the face region. The input is the facial image matrix. Server uses a detection model (for example, a trained classifier or convolutional network) to compute candidate bounding boxes and selects the most probable face region. Server then uses a facial landmark extraction library to compute coordinates of key facial points and normalizes these coordinates to a canonical coordinate system. The output is facial feature data, represented as a numerical feature vector or feature set suitable for expression analysis.

### Step 7:

Server receives and decodes the audio signal.
Server extracts the compressed audio data from the network message. The input is the encoded audio stream. Server decodes the stream into raw digital audio samples using an audio decoding library. The output is a sequence of audio samples in a time-domain representation stored in server memory.

### Step 8:

Server performs speech recognition and acoustic feature extraction.
Server runs a speech recognition component on the audio samples to obtain utterance content data as text. The input is the raw audio sample sequence. The speech recognition component segments the audio into frames, extracts spectral features, and decodes them with an acoustic model and language model to generate a text string. In parallel, server computes acoustic feature data by deriving parameters such as pitch, energy, spectral coefficients, and speaking rate from the audio frames. The output is a combination of utterance content data (text) and acoustic feature data (numerical vectors) associated with the session.

### Step 9:

Server aggregates multimodal features and user input information.
Server collects the facial feature data, the acoustic feature data, and any text directly input by the user through the terminal. The input is the set of data objects generated in previous steps. Server normalizes and aligns these data in time, and constructs a unified feature structure, for example by concatenating vectors and adding markers that indicate text sentiment. The output is a multimodal feature representation and user input information stored as a structured object.

### Step 10:

Server estimates the current emotional state.
Server executes the emotion estimation unit, which is implemented as a trained neural network or classifier, using the multimodal feature representation as input. The input is the structured feature object containing facial, acoustic, and textual information. The emotion estimation unit performs numerical computations, including matrix multiplications and activation functions, to compute a probability distribution over emotion categories and optional continuous emotion dimensions. The output is an emotional state object including at least one emotion label, confidence score, and optionally valence and arousal values.

### Step 11:

Server updates the history information of the emotional state.
Server writes the new emotional state object into a data store associated with the current user or session. The input is the emotional state object and the session identifier. Server appends this object to an existing sequence of emotion states or creates a new sequence if none exists. The output is updated history information of emotional states, stored in a database or structured storage.

### Step 12:

Server computes a user-specific emotion pattern.
Server invokes the learning control unit to process the history information of emotional states for the current user. The input is the time-ordered list of past emotional state objects. The learning control unit feeds this sequence into a sequential model (for example, a recurrent neural network) that aggregates temporal patterns into a fixed-length embedding. The internal computation includes recurrent updates of hidden states and application of non-linear activation functions. The output is a user-specific emotion pattern represented as an embedding vector or parameter set.

### Step 13:

Server derives prompt construction parameters from the emotion pattern.
Server analyzes the user-specific emotion pattern to compute parameters such as empathy level, desired response length, and specificity of advice. The input is the user-specific emotion pattern and, optionally, context information such as application type and device type. Server applies a mapping function or rule set that converts the embedding into scalar weights or discrete levels for different aspects of the prompt. The output is a set of prompt construction parameters that guide how the prompt sentence will be structured.

### Step 14:

Server constructs a prompt sentence for the generative AI model.
Server uses the prompt generation unit to build a prompt sentence based on the emotional state, the user input information, the context information, and the prompt construction parameters. The input is the emotional state object, user text, context labels, and numeric parameters (for example, empathy weight, specificity level). Server selects or composes a template and fills in slots with the current emotion description, the transcribed or typed user statement, and explicit instructions for response style. The output is a complete prompt sentence in natural language, such as:
“Customer is showing an angry facial expression and raised voice while complaining about a defective product in a store. The transcribed statement is: ‘This thing broke after just one day!’ Act as a polite store clerk. Propose specific phrases and actions that the clerk should take to calm the customer, apologize appropriately, and offer a realistic solution. Generate the response in a dialogue style.”

### Step 15:

Server sends the prompt sentence to the generative AI model and obtains a dialogue-type response.
Server inputs the constructed prompt sentence into the generative AI model via an application programming interface or local inference engine. The input is the prompt sentence represented as a sequence of tokens. The generative AI model performs internal computations, such as attention-based transformations and feedforward operations, and returns a generated token sequence representing a dialogue-type response. The output is a text string containing the generated response, for example:
“I am very sorry for the inconvenience. Let me check the product details for you, and we can offer either an immediate exchange or a refund, depending on your preference.”

### Step 16:

Server post-processes the dialogue-type response and prepares display information.
Server passes the generated response and the emotional state to the response presentation control unit. The input is the response text and emotional state object. Server may parse the response to extract key action instructions or adjust the wording according to device constraints and emotional sensitivity. Server then creates display information tailored to the terminal type, such as a short instruction for a wearable display or a complete chat-style text for a handheld terminal. The output is formatted display information, including text segments and optional presentation metadata.

### Step 17:

Server transmits the display information to the terminal.
Server packages the display information together with identifiers (session ID, message ID) and sends it back to the terminal using the communication interface. The input is the formatted display information generated in the previous step. Server performs serialization and encryption of the data. The output is a network response message containing the display information that arrives at the terminal.

### Step 18:

Terminal presents the dialogue-type response to the user or attendant.
Terminal receives the network response message from server and extracts the display information. The input is the serialized display information. Terminal renders this information on its display device, such as overlaying a short action instruction inside a smart-glasses field of view for an attendant, or showing a full conversational message in a chat interface for a user. Terminal may also use a text-to-speech engine to convert the response text into audible speech. The output is a visual and/or auditory presentation that the user or attendant can perceive and act upon.

### Step 19:

User or attendant reacts to the presented guidance and may provide further input.
User or attendant reads or listens to the response and performs corresponding actions, such as adjusting customer handling or continuing the conversation. The input is the presented guidance and the real-world situation. User or attendant may then enter additional text, speak again, or trigger another capture by interacting with the terminal. The output is new user input information that, when captured by terminal, becomes the next cycle's input to server, thereby enabling iterative refinement of emotional state estimation and prompt sentence generation.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

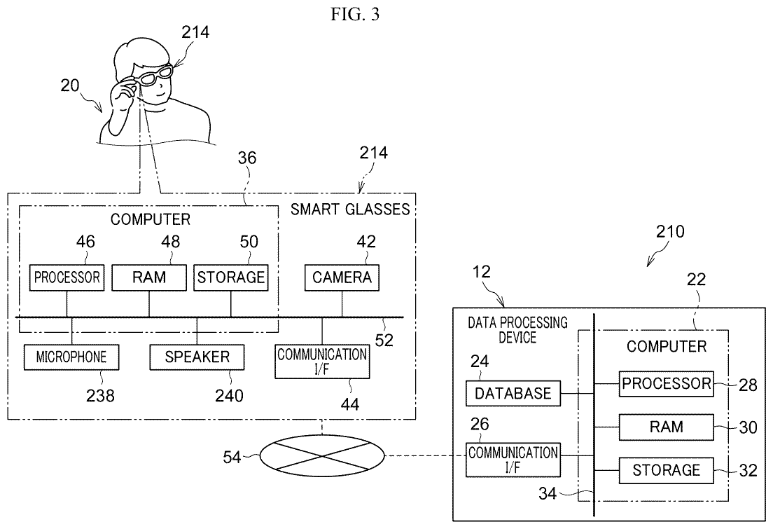

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

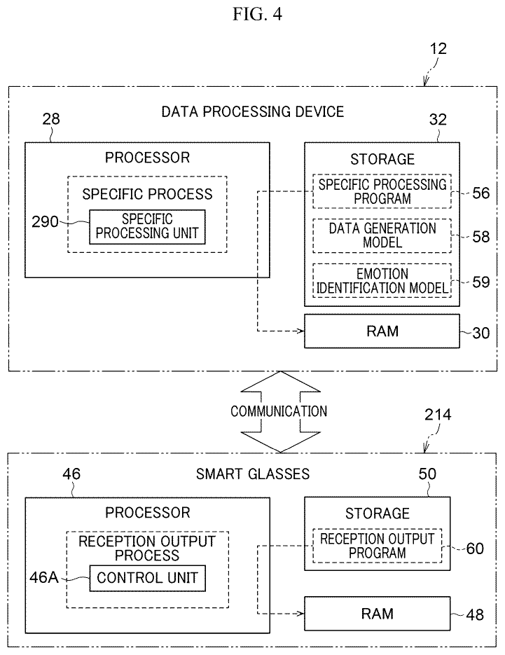

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

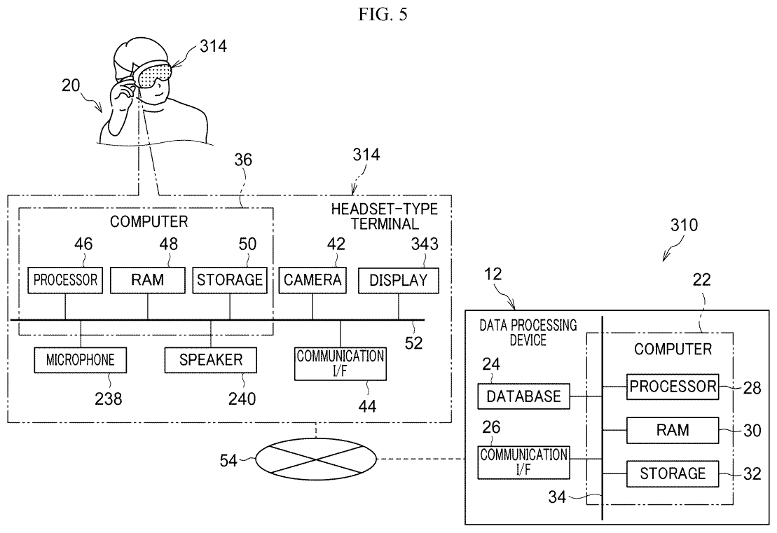

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

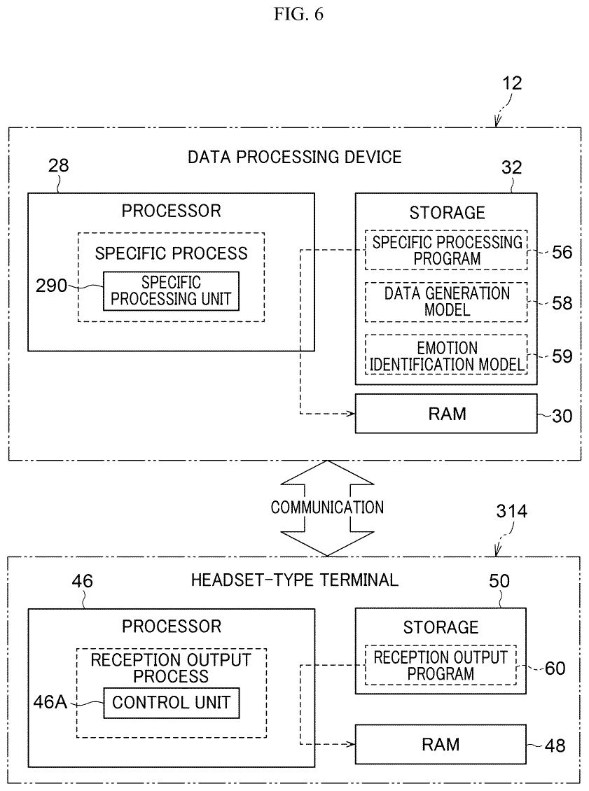

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

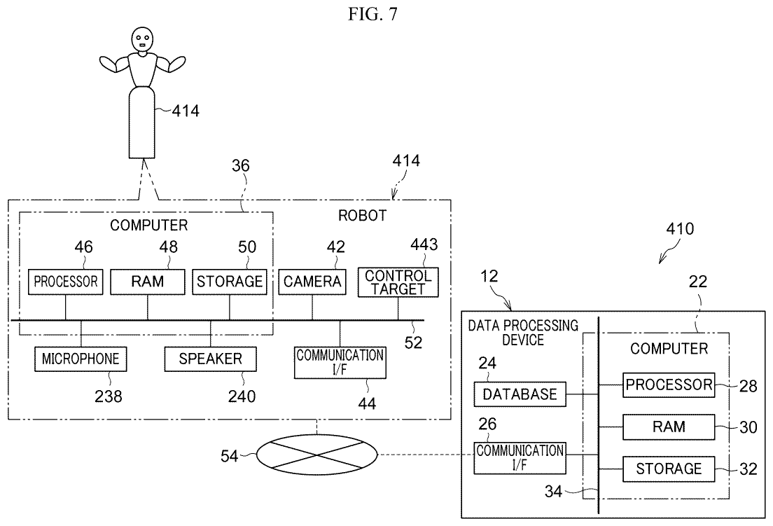

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

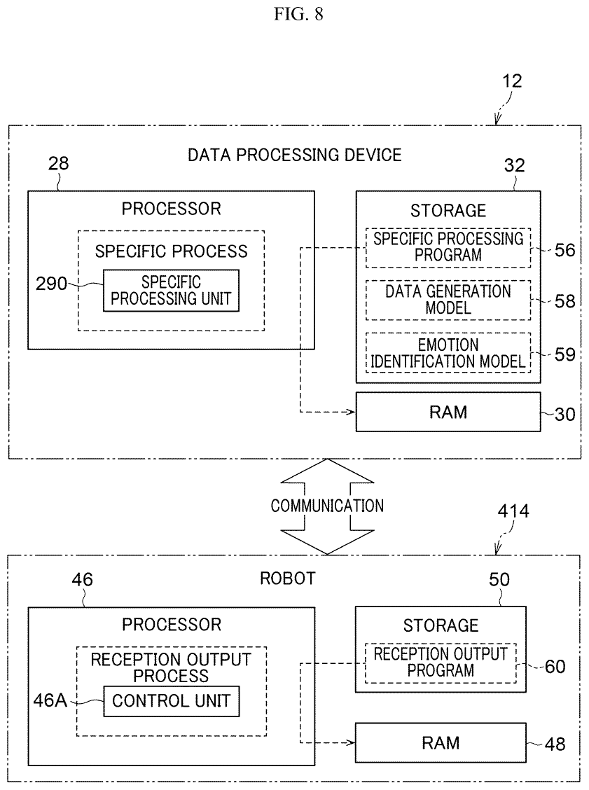

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

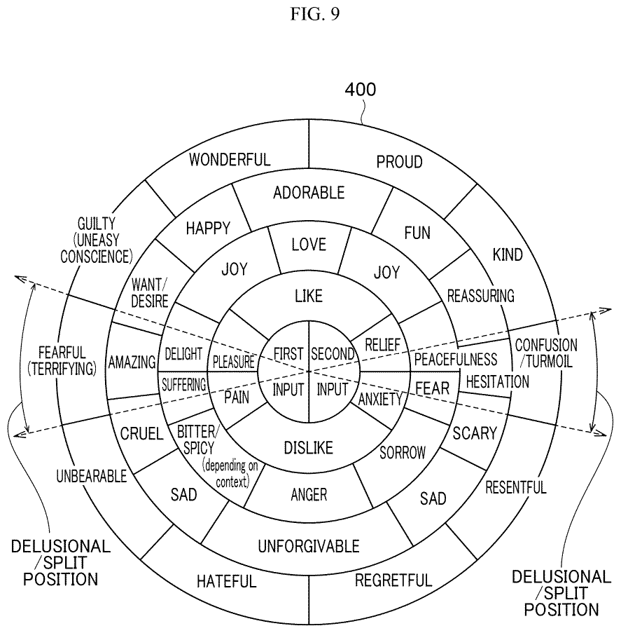

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

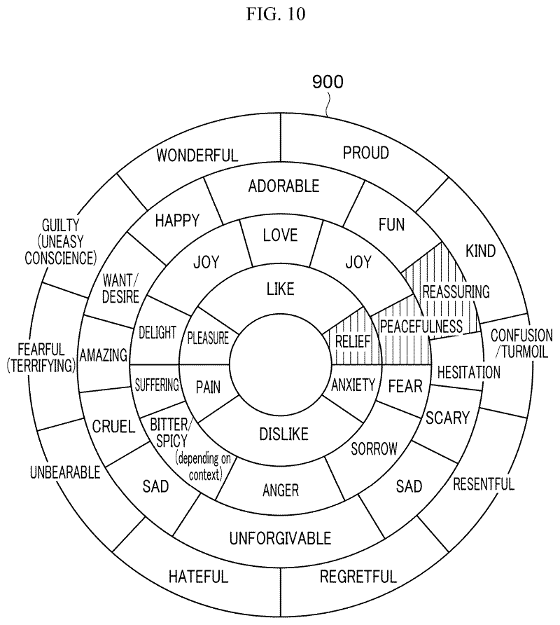

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
control an imaging device to acquire facial image data of a user,
perform image processing on the facial image data to detect a facial region and extract a plurality of facial feature points from the facial region so as to generate facial feature data,
execute emotion classification processing based on the facial feature data by using an external information processing service or internal computation to generate emotion data indicating an emotional state of the user,
acquire input information from the user as character string data or as voice recognition data,
execute character string generation processing based on the emotion data and the input information so as to generate a prompt sentence as a generation input sentence including at least the emotional state and the input information,
transmit the generation input sentence to a generative AI model included in a generative information processing apparatus that performs natural language processing, and instruct the generative AI model to generate a dialogue-type response sentence, and
acquire the response sentence from the generative AI model and generate response data for outputting the response sentence to a display unit of a terminal device of the user.

### Supplementary 2

The system according to supplementary 1,
wherein the processor is configured to cause the terminal device to execute extraction of the facial feature data and generation of the prompt sentence, and to cause a server device to execute the emotion classification processing and response sentence generation by the generative AI model, and to cause the terminal device and the server device to transmit and receive the facial feature data, the emotion data, the prompt sentence, and the response sentence via a communication network.

### Supplementary 3

The system according to supplementary 1,
wherein the processor is configured to control inclusion, in the prompt sentence, of personality information, speech style information, and response policy information of a virtual dialogue agent such that the response sentence generated by the generative AI model becomes a dialogue response that imitates the virtual dialogue agent in accordance with the emotional state of the user.

### Application Example 1

### Supplementary 1

A system comprising a processor,
wherein the processor is configured to
cause an information processing terminal carried or worn by a user to activate an imaging device as an image acquisition device and to acquire image data including a face of the user from the image acquisition device,
convert the image data into pixel data and apply a face region detection learning model to the pixel data to specify a face region of the user,
apply an expression analysis learning model to the specified face region and estimate, on the basis of pixel features of the face region, an emotional state of the user represented by an emotion label and an emotion score,
acquire, via an input interface of the information processing terminal, input information from the user based on text or speech, and generate structured data by associating the input information with the emotion label and the emotion score,
generate, on the basis of the structured data including the emotion label, the emotion score, and the input information, a prompt sentence in a natural language that explicitly represents the emotional state and a context of the user, and form the prompt sentence as instruction information to be input to a generative AI model of a generative information processing device,
transmit the prompt sentence to the generative AI model via a communication line and obtain, from the generative AI model in response to the prompt sentence, information including advertisement information or content information,
present the obtained advertisement information or content information to the user by controlling display of an information-providing character having a screen display unit and a sound output unit such that an expression or a manner of speaking of the information-providing character corresponds to the emotion label, and
record, in a storage device, the emotion label, the input information, the prompt sentence, the advertisement information or the content information, and an operation history of the user together with identification information, and accumulate the recorded information for use in generation of a subsequent prompt sentence or adjustment of model parameters.

### Supplementary 2

The system according to supplementary 1,
wherein the processor is configured to receive, from the generative AI model, the information including the advertisement information or the content information as response data including a plurality of candidate messages, select, on the basis of the emotion score and the operation history of the user, a message having a highest presentation priority among the plurality of candidate messages, and cause only the selected message to be displayed on the information processing terminal by using the information-providing character.

### Supplementary 3

The system according to supplementary 1,
wherein the processor is configured to operate the information-providing character as a dialogue window through which the user is able to input, in a natural language, dissatisfaction or anxiety in daily activities or tasks, and to include, in the prompt sentence, constraint conditions relating to a role and a manner of speaking of the information-providing character, so that the generative AI model generates dialogue responses that imitate the information-providing character.

### Example 2

### Supplementary 1

A system comprising a processor,
wherein the processor is configured to
acquire a facial image of a user by using an imaging function of an information processing terminal having an imaging function, and perform individual identification processing and facial expression state estimation processing based on the acquired facial image,
acquire input information expressed in natural language from the user, and perform emotion state estimation processing on the input information by using natural language processing,
integrate a result of the facial expression state estimation processing and a result of the emotion state estimation processing to determine an emotion state of the user,
generate a prompt sentence, based on the emotion state of the user, the input information from the user, and role information of a virtual dialogue entity, the prompt sentence being for instructing a generative artificial intelligence model that performs generative natural language response processing to generate a dialogue-format response, and configure the prompt sentence as input data to the generative artificial intelligence model,
acquire the dialogue-format response output from the generative artificial intelligence model, and transmit the dialogue-format response to the information processing terminal so that the dialogue-format response is displayed as a window-type dialogue screen of the virtual dialogue entity on the information processing terminal, and
record a plurality of dialogue histories between the user and the virtual dialogue entity, and include at least part of the dialogue histories in the prompt sentence to enable context-preserving response generation.

### Supplementary 2

The system according to supplementary 1,
wherein the processor is configured to
attach control information to the prompt sentence in generating the prompt sentence, the control information including at least one of a response tone corresponding to the emotion state of the user, a constraint on response content, and a behavioral policy of the virtual dialogue entity, thereby controlling the generative artificial intelligence model to generate a natural language response having emotional suitability.

### Supplementary 3

The system according to supplementary 1,
wherein the processor is configured to
set, as the virtual dialogue entity, an automatic response character that simulates a window-type character through which the user casually expresses dissatisfaction and anxiety regarding daily activities or work, and control the generative artificial intelligence model, via the prompt sentence, to imitate at least one of personality, manner of speaking, and response style of the automatic response character.

### Application Example 2

### Supplementary 1

A system comprising a processor,
wherein the processor is configured to
acquire, by using an image acquisition device, a facial image of a subject,
perform face region detection and facial feature extraction on the acquired facial image to generate facial feature data for expression analysis,
acquire, by using an audio acquisition device, an audio signal of the subject,
perform speech recognition and acoustic feature extraction on the acquired audio signal to generate utterance content data and acoustic feature data,
estimate an emotional state on a basis of the facial feature data, the acoustic feature data, and input information from a user, by using an emotion estimation unit,
construct a prompt sentence for instructing a generative artificial intelligence model to generate a response, on a basis of the emotional state, the input information from the user, and context information relating to a dialogue situation, by using a prompt generation unit,
learn a user-specific emotion pattern and update a construction policy of the prompt sentence, on a basis of the prompt sentence generated by the prompt generation unit and history information of the emotional state, by using a learning control unit,
input the prompt sentence to a generative artificial intelligence model and obtain a dialogue-type response output from the generative artificial intelligence model, by using a response acquisition unit, and
convert the obtained dialogue-type response and the emotional state into display information to be presented on a display device for an attendant or on a display device for the user, by using a response presentation control unit.

### Supplementary 2

The system according to supplementary 1,
wherein the processor is configured to
control the response presentation control unit so as to present the dialogue-type response generated by the generative artificial intelligence model, on a wearable display device for the attendant or on a portable display device, as a concrete action instruction for customer handling, and
control the learning control unit so as to dynamically adjust, for a subsequent prompt sentence, a strength of empathetic expressions and a degree of concreteness of proposed actions, on a basis of the presented action instruction and a change of the emotional state after execution of the action instruction.

### Supplementary 3

The system according to supplementary 1,
wherein the processor is configured to
control the response presentation control unit so as to present, on a screen or via an audio output device, a virtual dialogue agent based on the dialogue-type response generated by the generative artificial intelligence model, and
control the learning control unit so as to control the prompt generation unit to change a speaking style, a response length, and a specificity level of advice of the virtual dialogue agent, in accordance with the emotional state of the user and a dialogue history.

What is claimed is:

1. A system comprising:
circuitry configured to:
acquire, via an image acquisition device coupled to a communication interface connected to a packet-switched network, facial image data of a user;
perform image processing on the facial image data to detect a facial region and extract a plurality of facial feature points from the facial region, thereby generating facial feature data;
execute classification processing based on the facial feature data to generate emotion data indicating an emotional state of the user;
acquire input information from the user as character string data or voice recognition data via the communication interface;
construct a prompt data structure based on the emotion data and the input information, the prompt data structure including at least the emotional state and the input information as a generation input sequence for a generative information processing model; and
transmit the prompt data structure to the generative information processing model via the communication interface, acquire a response sentence generated by the generative information processing model, and transmit the response sentence as a notification data packet to a terminal device of the user via the packet-switched network.

2. The system according to claim 1, wherein the circuitry is configured to include, in the prompt data structure, personality information, speech style information, and response policy information of a virtual dialogue agent, such that the response sentence generated by the generative information processing model imitates the virtual dialogue agent in accordance with the emotional state of the user.

3. The system according to claim 2, wherein the virtual dialogue agent is configured as an interactive character entity through which the user expresses concerns regarding activities, and the circuitry is configured to control, via the prompt data structure, a response tone of the generative information processing model to match the emotional state.

4. The system according to claim 1, wherein the circuitry is configured to cause the terminal device to perform the extraction of the facial feature data and to cause a server device to execute the classification processing and response sentence generation by the generative information processing model, and to cause the terminal device and the server device to exchange the facial feature data, the emotion data, the prompt data structure, and the response sentence via the packet-switched network.

5. The system according to claim 1, wherein the facial feature points include characteristic locations corresponding to eyes, eyebrows, a nose region, and mouth corners of the user, and the classification processing maps configurations of the facial feature points to one of a plurality of predefined emotional state categories.

6. The system according to claim 5, wherein the classification processing is performed by applying a trained neural network model to the facial feature data, the trained neural network model having been trained on labeled facial expression data to output a probability distribution over the plurality of predefined emotional state categories.

7. The system according to claim 1, wherein the circuitry is configured to further acquire an audio signal of the user via an audio acquisition device, perform speech recognition and acoustic feature extraction on the audio signal to generate utterance content data and acoustic feature data, and estimate the emotional state based on a combination of the facial feature data, the acoustic feature data, and the input information.

8. The system according to claim 7, wherein the acoustic feature extraction includes extracting at least pitch, intensity, and prosody features from the audio signal, and the circuitry is configured to integrate the acoustic features with the facial feature data using a fusion module to produce a composite emotional state estimate.

9. The system according to claim 1, wherein the circuitry is configured to perform emotion state estimation processing on the input information by using natural language processing, and to integrate a result of the facial expression-based classification processing and a result of the natural language-based emotion state estimation processing to determine the emotional state of the user.

10. The system according to claim 1, wherein the circuitry is configured to record a plurality of dialogue history entries between the user and the generative information processing model, and to include at least part of the dialogue history entries in the prompt data structure to enable context-preserving response generation.

11. The system according to claim 10, wherein the circuitry is configured to select a subset of the dialogue history entries for inclusion in the prompt data structure based on a relevance score computed from the current input information and the emotional state.

12. The system according to claim 1, wherein the circuitry is configured to attach control information to the prompt data structure, the control information including at least one of a response tone parameter corresponding to the emotional state, a constraint on response content length, and a behavioral policy parameter of a virtual dialogue agent.

13. The system according to claim 1, wherein the circuitry is configured to learn a user-specific emotion pattern based on accumulated dialogue history and emotion data, and to update a construction policy of the prompt data structure based on the learned user-specific emotion pattern.

14. The system according to claim 13, wherein learning the user-specific emotion pattern includes computing a temporal distribution of emotional states over a plurality of dialogue sessions and adjusting weighting of emotion categories in the prompt data structure based on the temporal distribution.

15. The system according to claim 1, wherein the circuitry is configured to present the response sentence on the terminal device as a window-type dialogue screen of a virtual dialogue entity, and to update a visual representation of the virtual dialogue entity on a display controller of the terminal device based on the emotional state of the user.

16. The system according to claim 1, wherein the circuitry is configured to acquire the facial image data as a sequence of image frames from a video stream captured by the image acquisition device, and to perform the classification processing on each image frame to track changes in the emotional state of the user over time.

17. The system according to claim 1, wherein the circuitry is configured to present, together with the response sentence, content information or recommendation data selected based on the emotional state and the input information.

18. A system comprising:
circuitry configured to:
acquire, via an image acquisition device coupled to a communication interface connected to a packet-switched network, facial image data of a user;
perform image processing on the facial image data to detect a facial region and extract a plurality of facial feature points from the facial region, thereby generating facial feature data;
execute classification processing based on the facial feature data to generate emotion data indicating an emotional state of the user;
acquire input information from the user via the communication interface;
acquire an audio signal of the user via an audio acquisition device, perform acoustic feature extraction on the audio signal, and integrate the acoustic features with the facial feature data to produce a composite emotional state estimate;
construct a prompt data structure based on the composite emotional state estimate, the input information, and role information of a virtual dialogue agent, the prompt data structure including a generation input sequence for a generative information processing model;
transmit the prompt data structure to the generative information processing model via the communication interface, acquire a response sentence, and transmit the response sentence as a notification data packet to a terminal device of the user; and
record dialogue history entries and include at least part of the dialogue history entries in subsequent prompt data structures to enable context-preserving response generation.

19. The system according to claim 18, wherein the circuitry is configured to learn a user-specific emotion pattern based on accumulated dialogue history and emotion data, and to dynamically adjust a construction policy of the prompt data structure based on the learned user-specific emotion pattern.

20. A method performed by circuitry, the method comprising:
acquiring, via an image acquisition device coupled to a communication interface connected to a packet-switched network, facial image data of a user;
performing image processing on the facial image data to detect a facial region and extract a plurality of facial feature points from the facial region, thereby generating facial feature data;
executing classification processing based on the facial feature data to generate emotion data indicating an emotional state of the user;
acquiring input information from the user as character string data or voice recognition data via the communication interface;
constructing a prompt data structure based on the emotion data and the input information, the prompt data structure including at least the emotional state and the input information as a generation input sequence for a generative information processing model; and
transmitting the prompt data structure to the generative information processing model via the communication interface, acquiring a response sentence generated by the generative information processing model, and transmitting the response sentence as a notification data packet to a terminal device of the user via the packet-switched network.
